(19) United States
(12) Patent Application Publication
(10) Pub. No.: US 2026/0018925 A1
(43) Pub. Date: Jan. 15, 2026

(54) IN-MOLD COIL REPEATER ASSEMBLY FOR MOBILE DEVICE CASE

(71) Applicant: Toyota Motor Engineering & Manufacturing North America, Inc., Plano, TX (US)

(72) Inventors: Yanghe Liu, Ann Arbor, MI (US); Ercan Dede, Ann Arbor, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/949,673

(22) Filed: Nov. 15, 2024

Related U.S. Application Data
(63) Continuation-in-part of application No. 18/771,653, filed on Jul. 12, 2024, now abandoned.

(51) Int. Cl. H02J 50/00; H02J 7/00; H02J 50/12; H02J 50/50

(52) U.S. Cl. CPC H02J 50/005; H02J 7/0049; H02J 50/12; H02J 50/502

(57) ABSTRACT

A method of constructing a mobile device case includes placing a coil repeater assembly on pedestal members of a mold section, the repeater assembly including a wireless charging repeater circuit and a substrate, assembling a mold using the mold section to form a mold cavity, the cavity defining surfaces of the case body, injecting into the mold cavity heated thermoplastic material which flows around the repeater assembly, and removing the mold, the wireless charging repeater circuit having an inductive coil disposed on a surface of the substrate and a capacitor electrically coupled to ends of the coil. The wireless charging repeater circuit excludes electrical connection to an active component that supplies power. The coil repeater assembly is located within the case body such that, when the mobile device case is attached to a mobile device, the inductive coil is located proximate to a wireless charging coil in the mobile device.

### CROSS-REFERENCE TO RELATED APPLICATIONS

The present application is a continuation-in-part of and claims the benefit of priority to U.S. patent application Ser. No. 18/771,653 filed Jul. 12, 2024, which is incorporated herein by reference.

### TECHNICAL FIELD

Embodiments generally relate to protective cases for mobile devices. More particularly, embodiments relate to a mobile device case with a coil repeater assembly to assist with wireless charging.

### BACKGROUND

Wireless charging coils have been widely integrated into mobile devices such as smartphones. External charging pads are readily available for use with such mobile devices to provide power via an electromagnetic field for inductive charging a mobile device via an integrated charging coil.

### BRIEF SUMMARY

In some embodiments, a method of constructing a mobile device case includes placing a first coil repeater assembly on one or more pedestal members of a first mold section of a mold, wherein the first coil repeater assembly comprises a wireless charging repeater circuit and a substrate, assembling the mold using the first mold section and a second mold section to form a mold cavity, wherein the mold cavity defines surfaces of a case body for a mobile device case, and wherein the coil repeater assembly is positioned within the mold cavity, injecting heated thermoplastic material into the mold cavity such that the thermoplastic plastic material flows around the first coil repeater assembly, and removing the mold after the thermoplastic material in the mold has cooled to provide a solid case body for the mobile device case, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, and wherein the first coil repeater assembly is located within the case body such that, when the mobile device case is attached to a mobile device, the first inductive coil is located proximate to a wireless charging coil in the mobile device.

In some embodiments, a mobile device case for attachment to a mobile device includes a case body, and a first coil repeater assembly embedded within the case body, the first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is located within the case body such that, when the mobile device case is attached to a mobile device, the first inductive coil is located proximate to a wireless charging coil in the mobile device.

In some embodiments, a method of constructing a mobile device case includes placing a first coil repeater assembly on a first mold section of a mold, wherein the first coil repeater assembly comprises a wireless charging repeater circuit and a substrate, and wherein the substrate comprises a plastic sheet, assembling the mold using the first mold section and a second mold section to form a mold cavity, wherein the mold cavity defines surfaces of a case body for a mobile device case, and wherein the first coil repeater assembly lies in the mold cavity, injecting heated thermoplastic material into the mold cavity such that the thermoplastic plastic material flows over the first coil repeater assembly, and removing the mold after the thermoplastic material in the mold has cooled to provide a solid case body for the mobile device case, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is located within the case body such that, when the mobile device case is attached to a mobile device, the first inductive coil is located proximate to a wireless charging coil in the mobile device.

In some embodiments, a mobile device case for attachment to a mobile device includes a case body, and a first coil repeater assembly embedded within the case body, the first coil repeater assembly comprising a wireless charging repeater circuit and a substrate, the substrate comprising a plastic sheet, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is located within the case body such that, when the mobile device case is attached to a mobile device, the first inductive coil is located proximate to a wireless charging coil in the mobile device.

### BRIEF DESCRIPTION OF THE DRAWINGS

The various advantages of the embodiments will become apparent to one skilled in the art by reading the following specification and appended claims, and by referencing the following drawings, in which:

FIG. 1 provides a block diagram illustrating a conventional wireless charging configuration for a mobile device;

FIG. 2 provides a diagram illustrating an example of an improved wireless charging configuration for a mobile device according to one or more embodiments;

FIG. 3 provides a diagram illustrating an example of a mobile device case with a coil repeater assembly for wireless charging according to one or more embodiments;

FIG. 4A provides a diagram illustrating an example of a coil repeater assembly for wireless charging according to one or more embodiments;

FIG. 4B provides a diagram illustrating an example circuit of tuning capacitors for use in a coil repeater assembly according to one or more embodiments;

FIG. 5 provides a diagram illustrating another example of a coil repeater assembly for wireless charging according to one or more embodiments;

FIG. 6 provides a diagram illustrating another example of a coil repeater assembly for wireless charging according to one or more embodiments;

FIG. 7A provides a diagram illustrating an example of a stacked arrangement of coil repeater assemblies according to one or more embodiments;

FIG. 7B provides a diagram illustrating an example circuit of a stacked arrangement of coil repeater assemblies according to one or more embodiments;

FIGS. 8A-8B provide diagrams illustrating examples of case bodies for a mobile device case according to one or more embodiments;

FIG. 9 provides a flow diagram illustrating an example method of constructing a mobile device case with a coil repeater assembly for wireless charging according to one or more embodiments;

FIG. 10 provides a diagram illustrating an example of a mobile device case with a microchannel coil for wireless charging according to one or more embodiments;

FIG. 11 provides a flow diagram illustrating an example method of constructing a mobile device case with a microchannel coil for wireless charging according to one or more embodiments;

FIGS. 12A-12F illustrate examples of mold designs for constructing a mobile device case with an embedded coil repeater assembly for wireless charging according to one or more embodiments;

FIGS. 13A-13B illustrate examples of mobile device cases with an embedded coil repeater assembly for wireless charging according to one or more embodiments;

FIG. 14 provides a flow diagram illustrating an example method of constructing a mobile device case with an embedded coil repeater assembly for wireless charging according to one or more embodiments;

FIG. 15 illustrates another example of constructing a mobile device case with an embedded coil repeater assembly for wireless charging according to one or more embodiments;

FIGS. 16A-B illustrate examples of mobile device cases with an embedded coil repeater assembly for wireless charging according to one or more embodiments; and

FIG. 17 provides a flow diagram illustrating another example method of constructing a mobile device case with an embedded coil repeater assembly for wireless charging according to one or more embodiments.

### DESCRIPTION OF EMBODIMENTS

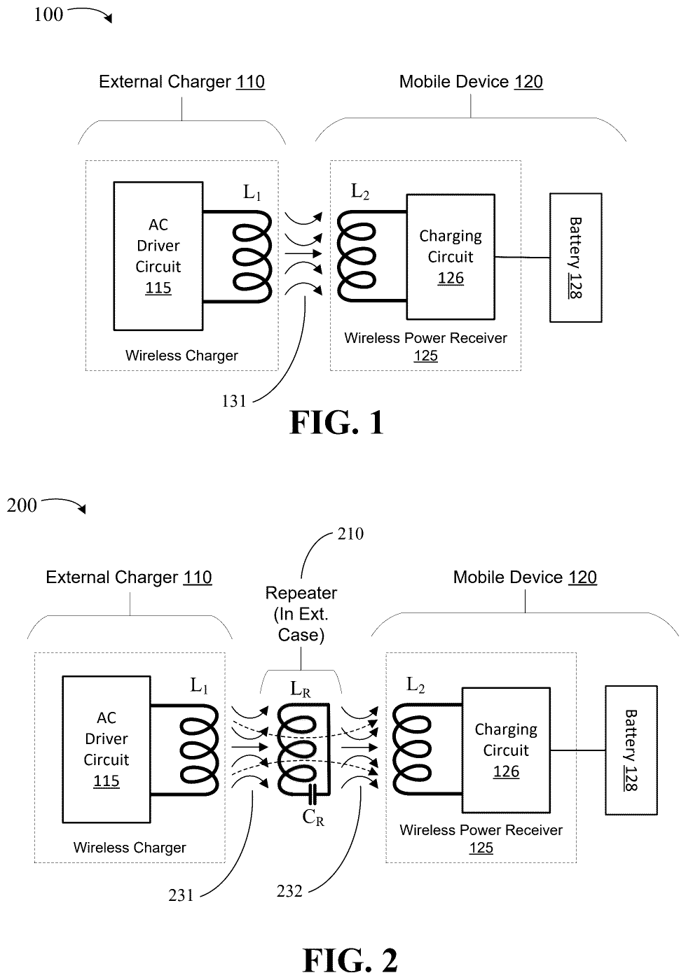

FIG. 1 provides a block diagram illustrating a conventional wireless charging configuration 100 for a mobile device. The wireless charging configuration includes an external charger 110 and a mobile device 120, which operate together using inductive wireless charging to charge the mobile device. As one example, the mobile device 120 can be a mobile telephone (e.g., a smartphone). The external charger 110 is a wireless charger—e.g., a wireless charging pad (such as, e.g., a pad that lays on a flat surface or magnetically attaches to a mobile device)—that includes an alternating current (AC) driver circuit 115 that is electrically coupled to a first inductive coil (inductor) L₁. The external charger is typically of a relatively lower power (e.g., 10-30 W). The mobile device 120 includes a wireless power receiver 125 and a battery 128. The wireless power receiver 125 includes a second inductive coil (inductor) L₂ that is electrically coupled to a charging circuit 126 (which can include, e.g., a rectifier and/or other electronic components). The second inductive coil L₂ is a wireless charging coil in the mobile device 120 that is used for wireless charging of the mobile device.

The AC driver circuit 115 is configured to provide AC power to the first coil L₁ sufficient to generate a magnetic field 131 (e.g., an electromagnetic field) which, in turn, passes (e.g., permeates or radiates) into the second coil L₂ (i.e., the wireless charging coil in the mobile device 120) when the second coil L₂ is in sufficiently close proximity to the first coil L₁. The AC driver circuit is further configured such that, in conjunction with the first coil L₁, the provided AC power is of a selected frequency fc-which can be designed to match (at least approximately) a resonant frequency of the wireless power receiver 125.

When the first coil L₁ and the second coil L₂ are in sufficiently close proximity and when power is applied by the AC driver circuit 115, the magnetic field 131 from L₁ passes (e.g., permeates or radiates) into the second coil L₂ (i.e., the wireless charging coil in the mobile device 120). The second coil L₂ (in conjunction with the charging circuit 125) then transfers power from the magnetic field 131 into electric power, via inductive coupling, to be supplied to charge the battery 128. In this way, the wireless power receiver 125 generates (e.g., provides) electric power to charge the battery 128 when the second coil L₂ is exposed to a changing magnetic field 131 from L₁.

Existing wireless charging technologies used in connection with mobile devices—such as the conventional wireless charging configuration 100 as described with reference to FIG. 1—encounter significant power transfer inefficiency and limitations when mobile devices are covered with thick (or dense) protective cases. For example, the longer transmission path caused by a thick case leads to an extremely slow charging speed or complete failure of the charging process. Such difficulties are alleviated by the improved wireless charging technology described below.

FIG. 2 provides a diagram illustrating an example of an improved wireless charging configuration 200 for a mobile device according to one or more embodiments, with reference to components and features described herein including but not limited to the figures and associated description. As shown in FIG. 2, the improved wireless charging configuration 200 includes the external charger 110 (FIG. 1, already discussed) and the mobile device 120 (FIG. 1, already discussed). The improved wireless charging configuration 200 as shown in FIG. 2 also includes a wireless charging repeater circuit 210, which is included as part of an external case (e.g., a protective case for the mobile device) (not shown in FIG. 2). The external case with the wireless charger repeater circuit 210 is typically attached to the mobile device 120 and, thus, the wireless charger repeater circuit 210 is situated between the external charger 110 and the wireless power receiver 125 of the mobile device 120. The external charger 110 is external to both the mobile device 120 and the external case that has the wireless charging repeater circuit 210.

The wireless charging repeater circuit 210 includes a third inductive coil (inductor) L_{R} and a tuning capacitor C_{R} that is electrically coupled to each end of the coil L_{R}. The capacitor C_{R} includes one or more physical capacitors, which are selected based on the particular requirements for the wireless charging repeater circuit 210 such as, e.g., capacitance value, size/space considerations, etc. The third inductive coil L_{R} and the capacitor C_{R} form a resonant circuit, and the components are selected such that the resonant frequency of the wireless charging repeater circuit 210 matches (at least approximately) the resonant frequency fc of the external charger 110 and/or the resonant frequency of the wireless power receiver 125. In some embodiments the wireless charging repeater circuit 210 includes additional electronic components (not shown in FIG. 2). Notably, however, in all embodiments the wireless charging repeater circuit 210 excludes electrical connection to any active component (including components such as, e.g., a battery, solar cell or other power source) that supplies power.

The external case is designed to be attached to the mobile device such that it covers at least a portion of the mobile device 120. For example, in embodiments the external case is a protective case that snaps on the back of the mobile device 120 and covers all or a portion of the back and edges of the mobile device 120. The inductive coil L_{R} of the wireless charging repeater circuit 210 is arranged such that, when the external case is attached to the mobile device 120, the inductive coil L_{R} is located proximate to the coil L₂ (i.e., the wireless charging coil in the mobile device 120) of the wireless power receiver 125 in the mobile device 120. For example, in embodiments when the external case is attached to the mobile device 120, the inductive coil L_{R} is located parallel to and within a short distance from the coil L₂ in the wireless power receiver 125 such that the center of the inductive coil L_{R} is aligned (at least approximately) with the center of the coil L₂.

In operation, the external case is attached to the mobile device 120 (e.g., snapped on the back of the mobile device 120). When the external charger 110 is placed in sufficiently close proximity to the external case (as attached to the mobile device 120), and power is applied by the AC driver circuit 115, a first magnetic field 231 (e.g., an electromagnetic field) from the coil L₁ passes (e.g., permeates or radiates) into the inductive coil L_{R} of the wireless charging repeater circuit 210. The wireless charging repeater circuit 210 then generates a second magnetic field 232 (e.g., an electromagnetic field) via the inductive coil L_{R} of the wireless charging repeater circuit 210 from the first magnetic field 231, via inductive coupling between the coil L₁ and the inductive coil L_{R}. The second magnetic field 232 passes (e.g., permeates or radiates) into the coil L₂. The coil L₂ then transfers power from the second magnetic field into electric power, via inductive coupling between the coil L₂ and the coil L_{R}, to be supplied to charge the battery 128 in the mobile device 120.

In some circumstances, some of the magnetic field 231 from the coil L₁ can pass through the coil L_{R} and into the coil L₂ (illustrated as dotted lines between the coil L₁ and the coil L₂). The amount of the magnetic field 231 that can reach the coil L₂ can depend on several factors, including the strength of the magnetic field 231, the thickness of the external case, among other factors. Further, the presence of the wireless charging repeater circuit 210 improves the focus of the flux to help correct any misalignment between the external charger 110 and the mobile device 120. As a result, in operation the coil L_{R} boosts flux linkage between the coil L₁ and the coil L₂ to enhance coupling and transfer of power between the external charger 110 and the mobile device 120.

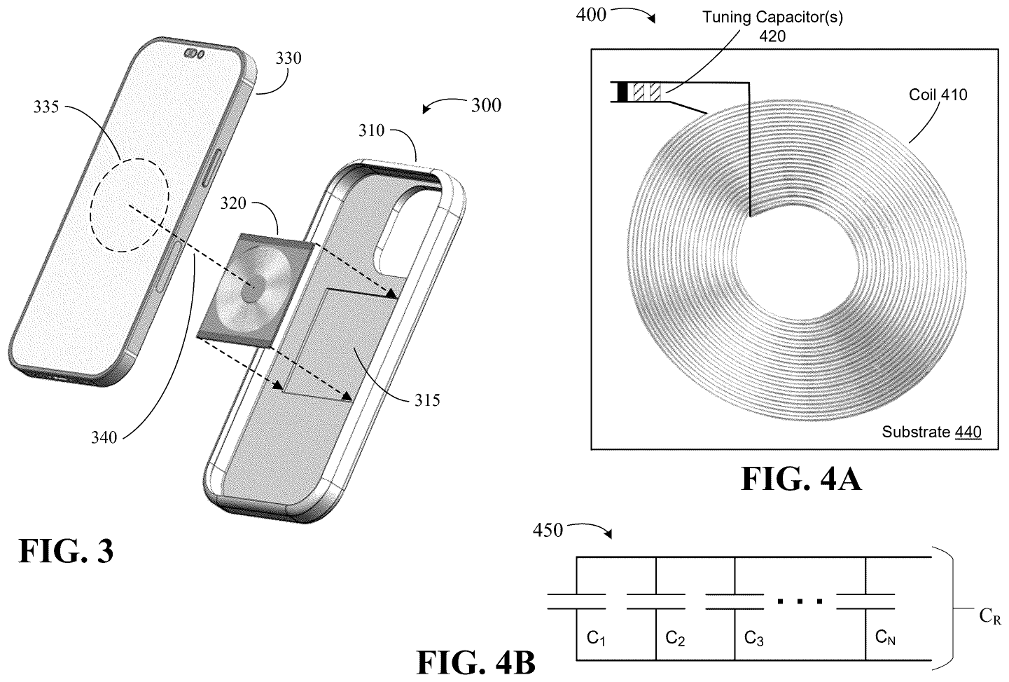

FIG. 3 provides a diagram illustrating an example of a mobile device case 300 with a coil repeater assembly for wireless charging according to one or more embodiments, with reference to components and features described herein including but not limited to the figures and associated description. As shown in FIG. 3, the mobile device case 300 includes a case body 310 and a coil repeater assembly 320 that is positioned on or within an interior surface of the case body 310. The mobile device case 300 is configured to be attached to the mobile device 330. For example, in some embodiments the mobile device case 300 is designed such that the mobile device case 300 snaps onto the back of the mobile device 330. The mobile device 330 corresponds to the mobile device 120 (FIGS. 1 and 2, already discussed) and, thus, includes a wireless charging coil L₂, where the location of the coil L₂ in the mobile device 330 is indicated by the dotted circle 335.

The coil repeater assembly 320 includes a wireless charging repeater circuit and a substrate. The wireless charging repeater circuit of the coil repeater assembly 320 corresponds to the wireless charging repeater circuit 210 (FIG. 2, already discussed) and, thus, includes an inductive coil L_{R} that is electrically coupled to a capacitor C_{R}. Notably, however, in all embodiments the wireless charging repeater circuit of the coil repeater assembly 320 excludes electrical connection to any active component (including components such as, e.g., a battery, solar cell or other power source) that supplies power. The substrate provides a supporting structure to hold or position the wireless charging repeater circuit. Further details regarding the coil repeater assembly 320 are provided herein with reference to FIGS. 4A-4B, 5 and 6.

The coil repeater assembly 320 is attached on or within an interior surface of the case body 310 (e.g., via an adhesive or other techniques for attachment). In some embodiments, the case body 310 includes a recessed region 315 to hold the coil repeater assembly 320 in position. In some embodiments, the recessed region 315 is of a depth that matches (at least approximately) the thickness of the coil repeater assembly 320 to permit the coil repeater assembly 320 of the mobile device case 300 to fit as closely as possible to the mobile device 330—e.g., such that in some embodiments the inductive coil L_{R} is positioned against the back of the mobile device 330 (or in some other embodiments there may be a very thin gap between the coil L_{R} and the back of the mobile device 330) when the mobile device case 300 is attached to the mobile device 330.

The case body 310 is designed to be attached to the mobile device 330—for example, by snapping onto the back of the mobile device 330. Thus, the particular configuration and dimensions of the case body 310 will depend on the configuration and dimensions of the mobile device 330—which in turn can depend on the manufacturer and/or model of the mobile device 330. In embodiments, the case body 310 also includes cutouts or spaces to permit use of various features of the mobile device 330 while the mobile device case 300 is attached thereto. As one example, if the mobile device 330 is a smartphone with a camera, the case body 310 can include an opening to allow external light to enter a camera sensor in the mobile device 330, thus enabling use of the camera while the mobile device case 300 is attached.

The coil repeater assembly 320 is arranged on or within the interior surface of the case body 310 such that, when the mobile device case 300 is attached to the mobile device 330, the inductive coil L_{R} of the wireless charging repeater circuit is located proximate to a wireless charging coil (e.g., the coil L₂) in the mobile device 330. For example, in embodiments, when the mobile device case 300 is attached to the mobile device 330, the coil L_{R} is located parallel to and within a short distance from the wireless charging coil (where the location of the wireless charging coil in the mobile device 330 is indicated by the dotted circle 335). As one example, in some embodiments the coil L_{R} is positioned against the back of the mobile device 330 when the mobile device case 300 is attached to the back of mobile device 330, and in some other embodiments there may be a very thin gap between the coil L_{R} and the back of the mobile device 330. Further, the center of the coil L_{R} is aligned (at least approximately) with the center of the wireless charging coil (indicated in FIG. 3 by the dotted line 340). The location of the wireless charging coil can depend on the manufacturer and model of the mobile device 330 and, thus, the case body 310 and the location of the coil repeater assembly 320 (and of any recessed region 315 to hold the coil repeater assembly 320) on or within the interior surface of the case body 310 can likewise be positioned based on the manufacturer and model of the mobile device 330 for which the case body 310 is intended to fit.

In operation, with the mobile device case 300 attached to the mobile device 330, the mobile device case 300 is placed in proximity to an external wireless charger (such as, e.g., the external charger 110 in FIGS. 1-2, already discussed), such that the external wireless charger, the coil repeater assembly 320 having a wireless charging repeater circuit (part of the mobile device case 300) and the mobile device 330 form a wireless charging configuration (e.g., such as, e.g., the wireless charging configuration 200 in FIG. 2, already discussed). As such, the wireless charging configuration operates as described with reference to the wireless charging configuration 200 in FIG. 2. In particular, when exposed to a changing magnetic field from the external wireless charger, the wireless charging repeater circuit of the coil repeater assembly 320 operates to generate a magnetic field that passes (e.g., permeates or radiates) into the wireless charging coil (e.g., the coil L₂) in the mobile device.

FIG. 4A provides a diagram illustrating an example of a coil repeater assembly 400 for use in wireless charging according to one or more embodiments, with reference to components and features described herein including but not limited to the figures and associated description. The coil repeater assembly 400 is to be placed on or within a surface of a mobile device case body (such as, e.g., the case body 310 of the mobile device case 300 in FIG. 3, already discussed). In embodiments the coil repeater assembly 400 corresponds to the coil repeater assembly 320 (FIG. 3, already discussed). As shown in FIG. 4, the coil repeater assembly 400 includes an inductive coil 410, one or more tuning capacitor(s) 420, and a substrate 440. The tuning capacitor(s) 420 are electrically coupled to each end of the coil 410, and the inductive coil 410 and the one or more tuning capacitor(s) 420 form a wireless charging repeater circuit that corresponds to the wireless charging repeater circuit 210 (FIG. 2, already discussed). As such, the inductive coil 410 corresponds to the inductive coil L_{R} (FIG. 2, already discussed), and the tuning capacitor(s) 420 correspond to the capacitor C_{R} (FIG. 2, already discussed). Notably, however, in all embodiments the wireless charging repeater circuit excludes electrical connection to any active component (including components such as, e.g., a battery, solar cell or other power source) that supplies power. The components L_{R} and C_{R} of the wireless charging repeater circuit are selected such that the resonant frequency of the wireless charging repeater circuit matches (at least approximately) the resonant frequency fc of the external charger and/or the resonant frequency of the wireless power receiver of the mobile device.

The substrate 440 provides a supporting structure to hold or position the wireless charging repeater circuit (or components thereof), such as the inductive coil 410 and/or the tuning capacitors 420. In some embodiments the substrate 440 is any material suitable for a printed circuit board (PCB), such as, e.g., a fiberglass/epoxy material (e.g., FR4). In some embodiments, the substrate 440 is a ceramic or crystalline material e.g., as used in manufacturing thin film circuits. In some embodiments, the substrate is a flexible film or thin film including a material such as used in thin film circuitry or flexible circuitry. Use of a flexible film or thin film as a substrate enables use in a case body that is flexible or pliable. As an example, in some embodiments, the substrate is of a thickness of approximately 1 mm or less for a PCB, or 0.5 mm or less for a thin film or flexible circuit.

The inductive coil 410 is a metallic inductive coil winding made of a metal such as copper, copper alloy, etc. In embodiments the coil 410 is a metallic trace (e.g., copper, copper alloy, etc.) that is disposed on a surface of the substrate 440 through one of any of a number of techniques known in electronics manufacturing (e.g., techniques used in manufacturing PCBs and/or thin film or flexible circuits). In some embodiments, the coil 410 is made of multiple thin copper traces arranged in a parallel or in a spiral or concentric configuration on the surface of the substrate. Each of these traces is narrow and thin, collectively acting like strands of a litz wire. They are isolated from each other with dielectric material inherent to the substrate. In some embodiments (e.g., limited planar size), a single flat copper winding path is used instead copper strands. It will be understood that, while the coil 410 illustrated in FIG. 4A is a circular winding (or an approximation thereto), the coil 410 can in embodiments be a winding of another shape such as, e.g., a square, a rectangle, etc. (or an approximation thereto).

The one or more tuning capacitor(s) 420 are one or more small capacitors such as, e.g., used in manufacturing PCBs and/or thin film or flexible circuits. In some embodiments the one or more tuning capacitor(s) 420 are thin film capacitors. The one or more capacitors 420 are selected based on the particular requirements for the wireless charging repeater circuit of the coil repeater assembly 400 such as, e.g., capacitance value, size/space considerations, etc. In some embodiments, the tuning capacitor(s) 420 are placed on the substrate 440 and electrically coupled to the coil 410 via, e.g., metallic traces. In some other embodiments, the tuning capacitor(s) 420 are placed elsewhere on or within the case body and electrically coupled to the coil 410 via, e.g., wires.

In some embodiments, the wireless charging repeater circuit of the coil repeater assembly 400 further includes a charge indicator element. In some embodiments, the charge indicator element includes an AC-powered LED light which connects to the circuit in the repeater board. When power transfer occurs via the wireless charging repeater circuit, the charge indicator is on. Once the battery is full and no wireless power is being transferred, the charge indicator is off. The charge indicator can be embedded into the protective case. Generally, the charge indicator should be exposed to the outside of the case rather than covered by the case, thus enabling a user to easily tell that the mobile device is being charged.

In some embodiments, the wireless charging repeater circuit of the coil repeater assembly 400 further includes a tuning subcircuit as an auxiliary tuning stage to help provide that the wireless charging repeater circuit resonates at the same frequency as other components of wireless power transfer system (e.g., the external charger and the charging circuit of the mobile device). The tuning subcircuit includes one or more tuning capacitors that can be selected (e.g., inserted or changed) to adjust or fine-tune the resonant frequency of the wireless charging repeater circuit. Further details regarding the tuning capacitors for a tuning subcircuit are provided herein with reference to FIG. 4B and FIG. 6. In some embodiments, the tuning subcircuit further includes other components (not shown in FIG. 4B or FIG. 6) in various circuit configurations such as, e.g., resistors, extra inductors, switches (e.g., IGBTs) for even more complex applications, etc.

FIG. 4B provides a diagram illustrating an example circuit 450 of tuning capacitors for use in a coil repeater assembly according to one or more embodiments, with reference to components and features described herein including but not limited to the figures and associated description. The circuit 450 of tuning capacitors corresponds to the tuning capacitor C_{R} (FIG. 2, already discussed) and/or to the tuning capacitor(s) 420 (FIG. 4A, already discussed). As shown in FIG. 4B, the circuit 450 includes one or more capacitors C₁, C₂, C₃, . . . C_{N} that are electrically coupled or connected in parallel. The capacitors C₁, C₂, C₃, . . . C_{N} are selected based on the particular requirements for the wireless charging repeater circuit of the coil repeater assembly 400 such as, e.g., capacitance value, size/space considerations, etc. In some embodiments, the tuning capacitors C₁, C₂, C₃, . . . C_{N} are coupled or connected in other circuit configurations (e.g., series, series-parallel, etc.). In embodiments the tuning capacitors can be selected (e.g., inserted or changed) as part of a tuning subcircuit to adjust or fine-tune the resonant frequency of the wireless charging repeater circuit.

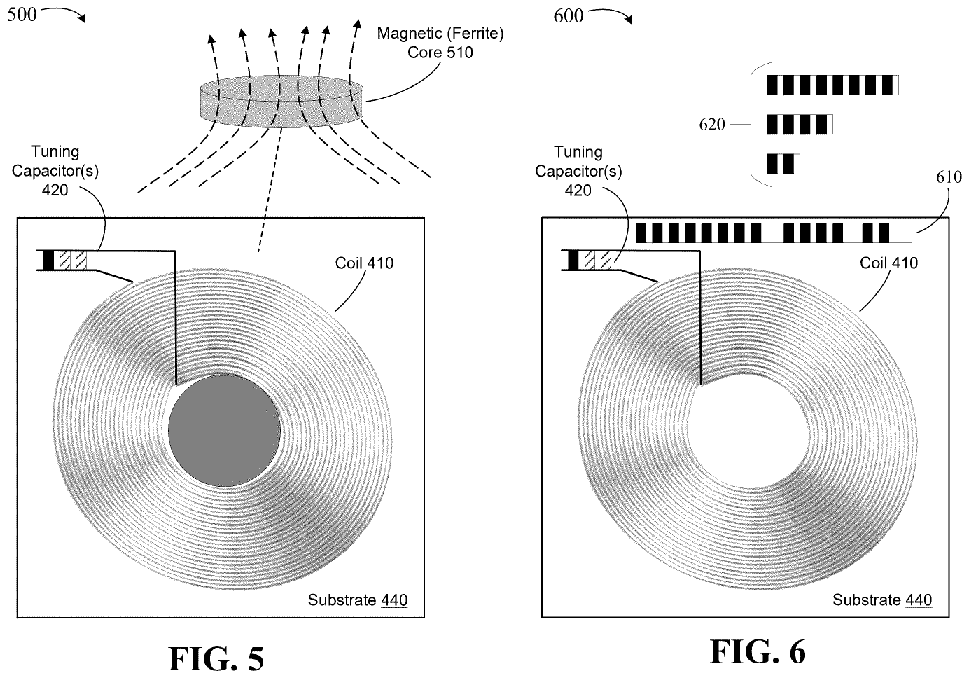

FIG. 5 provides a diagram illustrating an example of a coil repeater assembly 500 for use in wireless charging according to one or more embodiments, with reference to components and features described herein including but not limited to the figures and associated description. In embodiments the coil repeater assembly 500 corresponds to the coil repeater assembly 320 (FIG. 3, already discussed). The coil repeater assembly 500 includes several components that are illustrated and discussed with reference to the coil repeater assembly 400 in FIG. 4 (including the inductive coil 410 and the tuning capacitors 420 of the wireless charging repeater circuit), and discussion of such components will not be repeated except as necessary to describe the embodiments of FIG. 5. In addition to those components, the coil repeater assembly 500 also includes a magnetic core 510 such as, e.g., a ferrite core. The magnetic core 510 is arranged in the interior of the coil L_{R} of the wireless charging repeater circuit; in embodiments the coil L_{R} is wound around the magnetic core 510. The magnetic core 510 can be inserted to increase the magnetic field in the center area (e.g., to focus the magnetic field or to prevent magnetic leakage to air).

FIG. 6 provides a diagram illustrating an example of a coil repeater assembly 600 for use in wireless charging according to one or more embodiments, with reference to components and features described herein including but not limited to the figures and associated description. In embodiments the coil repeater assembly 600 corresponds to the coil repeater assembly 320 (FIG. 3, already discussed). The coil repeater assembly 600 includes several components that are illustrated and discussed with reference to the coil repeater assembly 400 in FIG. 4 (including the inductive coil 410 and the tuning capacitors 420 of the wireless charging repeater circuit), and discussion of such components will not be repeated except as necessary to describe the embodiments of FIG. 6. In addition to those components, the coil repeater assembly 600 also includes a slot 610 configurable to hold one or more tuning capacitors 620 (e.g., to provide a capacitor circuit such as the circuit 450 (e.g., a tuning subcircuit) in FIG. 4B, already discussed), which can include one or more supplementary capacitors. The slot 610 includes one or more socket(s) to hold one or more of the tuning capacitors 620, where the socket(s) are electrically coupled or connected to each end of the inductive coil 410 to provide electrical coupling or connectivity of the capacitor(s) 620 to each end of the coil 410. If the slot 610 includes more than one socket, in some embodiments the sockets are connected in parallel, in some embodiments the sockets are connected in series, and in some embodiments the sockets are connected in other configurations (e.g., series-parallel).

The modular configuration provided by the slot 610 and the tuning capacitors 620 provides flexibility in design of the wireless charging repeater circuit of the coil repeater assembly 600. For example, to enable use of higher total capacitance for the tuning capacitor C_{R}, the slot 610 can hold additional individual capacitors that are electrically coupled in parallel to provide an increased capacitance value. Moreover, a selection of modular tuning capacitors 620 (e.g., of different capacitance values) can be provided to enable tuning or customization of the wireless charging repeater circuit for different models of the mobile device (e.g., the mobile device 330).

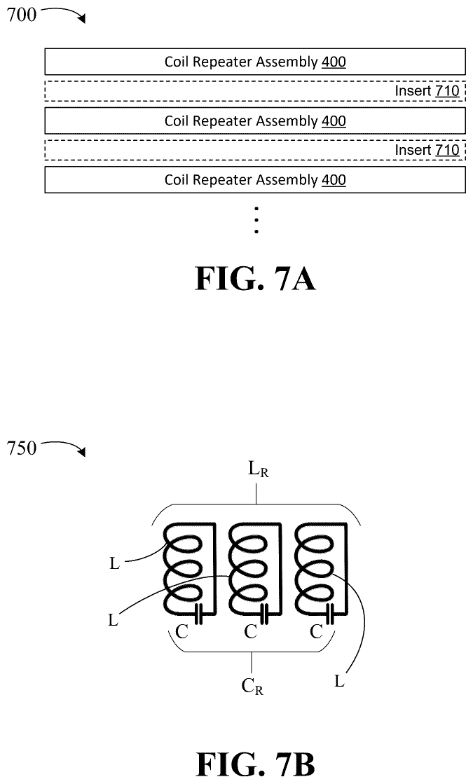

FIG. 7A provides a diagram illustrating an example of a stacked arrangement 700 of coil repeater assemblies (side view) according to one or more embodiments, with reference to components and features described herein including but not limited to the figures and associated description. The stacked arrangement 700 is used in embodiments as a wireless charging repeater circuit in the mobile device case 300 for wireless charging. As shown in FIG. 7A, the stacked arrangement 700 includes a plurality of layers, including a plurality of coil repeater assemblies 400. In some embodiments, the stacked arrangement 700 also includes one or more optional insert layers 710. Each insert layer 710 is arranged between and adjacent to two coil repeater assemblies 400. For example, as illustrated in FIG. 7A the layers of the stacked arrangement 700 are placed adjacent to each other (e.g., pressed together) in a stacked formation. The insert layer 710 comprises an electrically-insulating layer, and can be used, e.g., to adjust the spacing between any two coil repeater assemblies 400.

Although the example stacked arrangement 700 as illustrated in FIG. 7A shows five layers—comprising three coil assemblies 400, each separated by an insert layer 710, it will be understood that or fewer or additional layers can be included in any particular embodiment of the stacked arrangement 700. For example, the stacked arrangement 700 can include two layers (two coil repeater assemblies 400), three layers (two coil repeater assemblies 400 separated by an insert layer 710, or three coil repeater assemblies 400 without an insert layer 710), etc. Furthermore, while the example stacked arrangement 700 as illustrated in FIG. 7A shows a plurality of coil repeater assemblies 400, it will be understood that one or more coil repeater assemblies 500 or one or more coil repeater assemblies 600 can, in any particular embodiment, be substituted for one or more coil repeater assemblies 400 in the stacked arrangement 700.

FIG. 7B provides a diagram illustrating an example wireless charging repeater circuit 750 for a stacked arrangement of coil repeater assemblies (e.g., the stacked arrangement 700 in FIG. 7A) according to one or more embodiments, with reference to components and features described herein including but not limited to the figures and associated description. As shown in FIG. 7B, the wireless charging repeater circuit 750 includes a series of coils L, each coil L corresponding to a coil in one of the coil repeater assemblies 400 in the stacked arrangement 700. As illustrated in FIG. 7B, the wireless charging repeater circuit 750 also includes one or more tuning capacitor(s) C_{R} electrically coupled to each end of one of the coils L. When combined in a stacked arrangement, the coils L provide the coil L_{R} of the wireless charging repeater circuit 750 and the capacitors C provide the tuning capacitor C_{R}. In embodiments the wireless charging repeater circuit 750 can include additional components not shown in FIG. 7B. While the example wireless charging repeater circuit 750 as illustrated in FIG. 7B shows three coils/tuning capacitors (representing three stacked coil assemblies), it will be understood that or fewer or additional coils/tuning capacitors (representing fewer or additional stacked coil assemblies), can be included in any particular embodiment of the wireless charging repeater circuit 750.

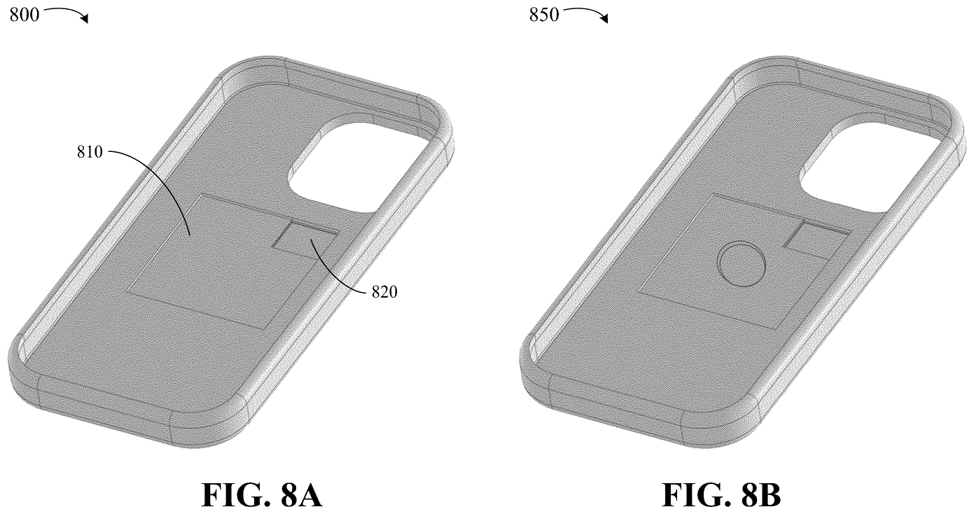

FIGS. 8A-8B provide diagrams illustrating examples of a case body 800 and a case body 850 for a mobile device case according to one or more embodiments, with reference to components and features described herein including but not limited to the figures and associated description. Each of the case body 800 and the case body 850 are alternative examples for use in a mobile device case (such as, e.g., the mobile device case 300 in FIG. 3, already discussed). As shown in FIG. 8A, the case body 800 includes a first recessed region 810 and a second recessed region 820, where the depth of the second recessed region 820 is different (e.g., deeper) than the depth of the first recessed region 810. The first recessed region 810 is similar to the recessed region 315 (FIG. 3, already discussed), such that in embodiments the recessed region 810 is of a depth that matches (at least approximately) the thickness of most of the coil repeater assembly-except for, e.g., an area where the tuning capacitor(s) or other circuitry of the wireless charging repeater circuit that is in the coil repeater assembly are located). The second recessed region 820 is located in an area that corresponds to the location of the tuning capacitor(s) or other circuitry. In embodiments the second recessed region 820 is of a depth that matches (at least approximately) the thickness of the portion of the coil repeater assembly that includes tuning capacitor(s) or other circuitry. Thus, together the first recessed region 810 and the second recessed region 820 hold the coil repeater assembly (such as the coil repeater assembly 320 in FIG. 3, already discussed).

Turning now to FIG. 8B, the illustrated case body 850 typically includes the features of the case body 800 (FIG. 8A) (i.e., the first recessed region 810 and the second recessed region 820), along with a third recessed region 870. The third recessed region 870 is typically deeper than the first recessed region 810. The third recessed region 870 is located in an area that corresponds to the location of a magnetic core (e.g., the magnetic core 510 in FIG. 5, already discussed) in the wireless charging repeater circuit that is in the coil repeater assembly. In embodiments the third recessed region 870 is of a depth that matches (at least approximately) the thickness of the portion of the coil repeater assembly that includes the magnetic core. In some embodiments, the case body 850 includes the first recessed region 810 and third recessed region 870 but not the second recessed region 820 (e.g., use of thin film capacitor(s) as the tuning capacitor(s)).

Each of the case body 800 and the case body 850 is designed to be attached to a mobile device (such as, e.g., the mobile device 330 in FIG. 3)—for example, by snapping onto the back of the mobile device. Thus, the particular configuration and dimensions of the case body 800 and/or the case body 850 will depend on the configuration and dimensions of the mobile device—which in turn can depend on the manufacturer and/or model of the mobile device. Further, in embodiments, when a mobile device case with the case body 800 or the case body 850 is attached to the mobile device, the center of the coil L_{R} of the wireless charging repeater circuit is aligned (at least approximately) with the center of the wireless charging coil in the mobile device. The location of the wireless charging coil can depend on the manufacturer and model of the mobile device and, thus, the location of the coil repeater assembly (and of the first recessed region 810 to hold the greater portion of the coil repeater assembly) on or within the interior surface of the the case body 800 and/or the case body 850 can likewise be positioned based on the manufacturer and model of the mobile device for which the case body 800 and/or the case body 850 is intended to fit.

In embodiments, the case body 800 and/or the case body 850 also include cutouts or spaces to permit use of various features of the mobile device while the mobile device case is attached thereto. As one example, if the mobile device is a smartphone with a camera, the case body 800 and/or the case body 850 can include an opening to allow external light to enter a camera sensor in the mobile device, thus enabling use of the camera while the mobile device case is attached.

In operation, with a mobile device case having the case body 800 or the case body 850 attached to the mobile device (such as, e.g., the mobile device 330), the mobile device case is placed in proximity to an external wireless charger (such as, e.g., the external charger 110 in FIGS. 1-2, already discussed), such that the external wireless charger, the with a coil repeater assembly having a wireless charging repeater circuit (part of the mobile device case)—and the mobile device form a wireless charging configuration (e.g., such as, e.g., the wireless charging configuration 200 in FIG. 2, already discussed). As such, the wireless charging configuration operates as described with reference to the such as, e.g., the wireless charging configuration 200 in FIG. 2. In particular, when exposed to a changing magnetic field from the external wireless charger, the wireless charging repeater circuit of the coil repeater assembly operates to generate a magnetic field that passes (e.g., permeates or radiates) into the wireless charging coil (e.g., the coil L₂) in the mobile device.

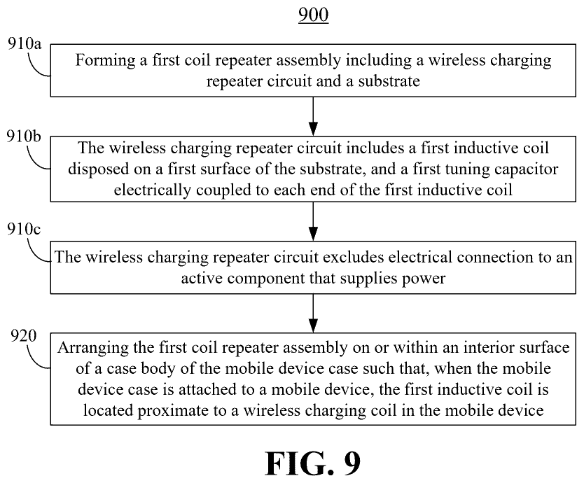

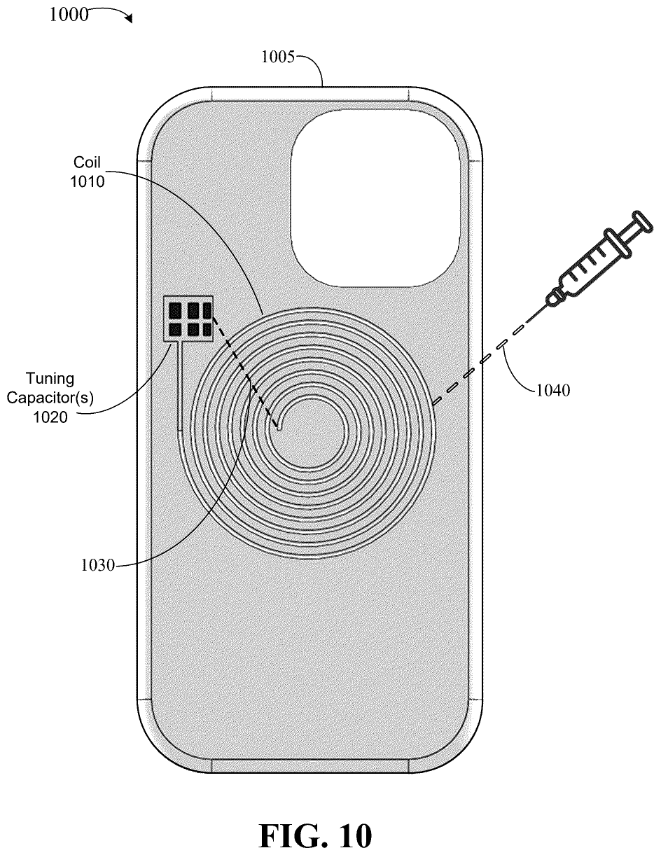

FIG. 9 provides a flow diagram illustrating an example method 900 of constructing a mobile device case with a coil repeater assembly for wireless charging according to one or more embodiments, with reference to components and features described herein including but not limited to the figures and associated description. In embodiments, the mobile device case corresponds to one or more of the mobile device case 300 (FIG. 3, already discussed), the mobile device case with the case body 800 (FIG. 8A, already discussed), and/or the mobile device case with the case body 850 (FIG. 8B, already discussed). In embodiments, the coil repeater assembly corresponds to one or more of the coil repeater assembly 320 (FIG. 3, already discussed), the coil repeater assembly 400 (FIG. 4, already discussed), the coil repeater assembly 500 (FIG. 5, already discussed), and/or the coil repeater assembly 600 (FIG. 6, already discussed).

Block 910a provides for forming a first coil repeater assembly including a wireless charging repeater circuit and a substrate, where at block 910b the wireless charging repeater circuit includes a first inductive coil disposed on a first surface of the substrate, and a first tuning capacitor electrically coupled to each end of the first inductive coil, and where at block 910c the wireless charging repeater circuit excludes electrical connection to an active component that supplies power. Block 920 provides for arranging the first coil repeater assembly on or within an interior surface of a case body of the mobile device case such that, when the mobile device case is attached to a mobile device, the first inductive coil is located proximate to a wireless charging coil in the mobile device. In embodiments, the wireless charging repeater circuit corresponds to the wireless charging repeater circuit 210 (FIG. 2, already discussed).

FIG. 10 provides a diagram illustrating an example of a mobile device case 1000 with a microchannel coil for wireless charging according to one or more embodiments, with reference to components and features described herein including but not limited to the figures and associated description. As illustrated in FIG. 10, the mobile device case 1000 includes a case body 1005 having an inductive coil 1010, along with one or more tuning capacitor(s) 1020. The inductive coil 1010 is a conductor-filled microchannel coil formed in the case body 1005—e.g., in the interior surface of the case body 1005. For example, in embodiments the inductive coil 1010 is formed in the case body by molding a microchannel coil into the case body 1005 and then injecting a conductive liquid (e.g., liquid metal) 1040 into the microchannel coil. In embodiments, the injected liquid metal remains in liquid (or semi-liquid) state, such that the inductive coil 1010 remains flexible or pliable-which, in turn, enables use in a case body that is flexible or pliable.

In some embodiments, the microchannel coil that provides the inductive coil 1010 is formed within the case body 1005 via injection molding, three-dimensional (3D) printing, or other processes. The microchannel coil can be formed or refined via laser cutting, micro-milling or other techniques. Once the microchannel coil has been formed and/or refined, next a conductive fluid or paste is injected into the microchannel coil, and then the microchannel coil is sealed via 3D printing, epoxy curing or other techniques for sealing. In some embodiments, the microchannel coil is formed and the metal fluid/paste is placed in the microchannel coil which is then sealed, all via 3D printing, where materials are switched between non-conductive and conductive materials during the 3D printing process to create the microchannel coil (e.g., in the case body formed with a non-conductive material) that is filled with a conductive material (e.g., metallic liquid or paste) then sealed (e.g., with a non-conductive material).

In some embodiments, a magnetic core (e.g. a ferrite core, not shown in FIG. 10) is arranged in the center of the microchannel coil of the inductive coil 1010. Such a magnetic core operates as described herein with reference to the magnetic core 510 (FIG. 5, already discussed). In some embodiments, the magnetic core is placed in the center of the microchannel coil via 3D printing (e.g., as part of an integrated 3D printing process). In some embodiments, the magnetic core is made of a thin magnetic plate (e.g., a thin ferrite plate) which is placed at the center of the microchannel coil, e.g. in a recessed region/cavity (not shown in FIG. 10). For example, the recessed region can be similar to the recessed region 870 (FIG. 8B, already discussed) designed to hold the thin magnetic plate in the center of the microchannel coil.

The inductive coil 1010 and the tuning capacitor(s) 1020 form a wireless charging repeater circuit that corresponds to the wireless charging repeater circuit 210 (FIG. 2, already discussed). As such, the inductive coil 1010 corresponds to the inductive coil L_{R} (FIG. 2, already discussed), and the tuning capacitor(s) 1020 correspond to the capacitor C_{R} (FIG. 2, already discussed). The tuning capacitor(s) 1020 are electrically coupled to each end of the inductive coil 1010. For example, in embodiments one end of the tuning capacitor(s) 1020 are coupled to a near end of the inductive coil 1010, and the other end of the tuning capacitor(s) 1020 are coupled to a far end of the inductive coil 1010 via an electronic path 1030 (e.g., a metallic wire or metallic wire trace embedded in the case body 1005). Notably, however, in all embodiments the wireless charging repeater circuit excludes electrical connection to any active component (including components such as, e.g., a battery, solar cell or other power source) that supplies power. The components L_{R} and C_{R} of the wireless charging repeater circuit are selected such that the resonant frequency of the wireless charging repeater circuit matches (at least approximately) the resonant frequency fc of the external charger and/or the resonant frequency of the wireless power receiver of the mobile device. The tuning capacitor(s) 1020 can include one or more physical capacitors (e.g., connected in parallel), and can include thin film capacitor(s). In some embodiments, the case body 1005 includes a recessed region to hold the tuning capacitor(s) 1020. In some embodiments, the case body 1005 includes a socket to hold at least one of the plurality of physical capacitors, where the at least one of the plurality of physical capacitors is removeable. The socket is electrically coupled or connected to each end of the inductive coil 1010 to provide electrical coupling or connectivity of the tuning capacitor(s) 1020 to each end of the coil 1010.

The case body 1005 is designed to be attached to a mobile device (such as, e.g., the mobile device 330 in FIG. 3)—for example, by snapping onto the back of the mobile device. Thus, the particular configuration and dimensions of the case body 1005 will depend on the configuration and dimensions of the mobile device—which in turn can depend on the manufacturer and/or model of the mobile device. In embodiments, the case body 1005 also includes cutouts or spaces to permit use of various features of the mobile device while the mobile device case 1000 is attached thereto. As one example, if the mobile device is a smartphone with a camera, the case body 1005 can include an opening to allow external light to enter a camera sensor in the mobile device, thus enabling use of the camera while the mobile device case 1000 is attached.

The inductive coil 1010 is manufactured within the case body 1005 such that, when the mobile device case 1000 is attached to the mobile device, the inductive coil 1010 of the wireless charging repeater circuit is located proximate to a wireless charging coil (e.g., the coil L₂) in the mobile device. For example, in embodiments, when the mobile device case 1000 is attached to the mobile device, the coil 1010 is located parallel to and within a short distance from the wireless charging coil in the mobile device. Further, the center of the coil 1010 is aligned (at least approximately) with the center of the wireless charging coil in the mobile device. The location of the wireless charging coil can depend on the manufacturer and model of the mobile device and, thus, the location of the coil 1010 within the case body 1005 can likewise be positioned based on the manufacturer and model of the mobile device for which the case body 1005 is intended to fit.

In operation, with the mobile device case 1000 attached to the mobile device (such as, e.g., the mobile device 330), the mobile device case 1000 is placed in proximity to an external wireless charger (such as, e.g., the external charger 110 in FIGS. 1-2, already discussed), such that the external wireless charger, the wireless charging repeater circuit (part of the mobile device case 1000)—and the mobile device form a wireless charging configuration (e.g., such as, e.g., the wireless charging configuration 200 in FIG. 2, already discussed). As such, the wireless charging configuration operates as described with reference to the wireless charging configuration 200 in FIG. 2. In particular, when exposed to a changing magnetic field from the external wireless charger, the wireless charging repeater circuit operates to generate a magnetic field that passes (e.g., permeates or radiates) into the wireless charging coil (e.g., the coil L₂) in the mobile device.

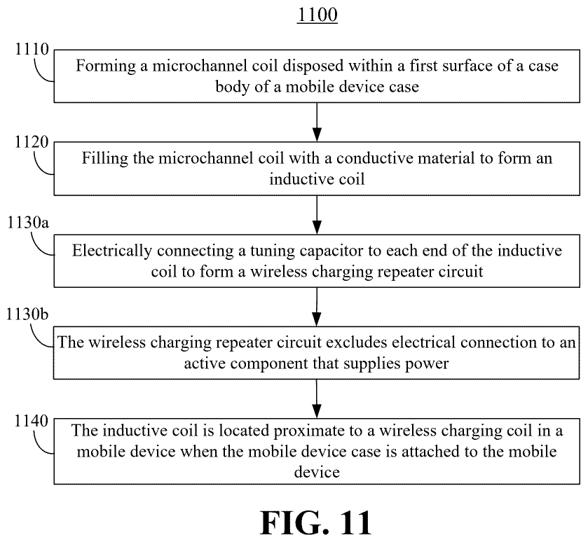

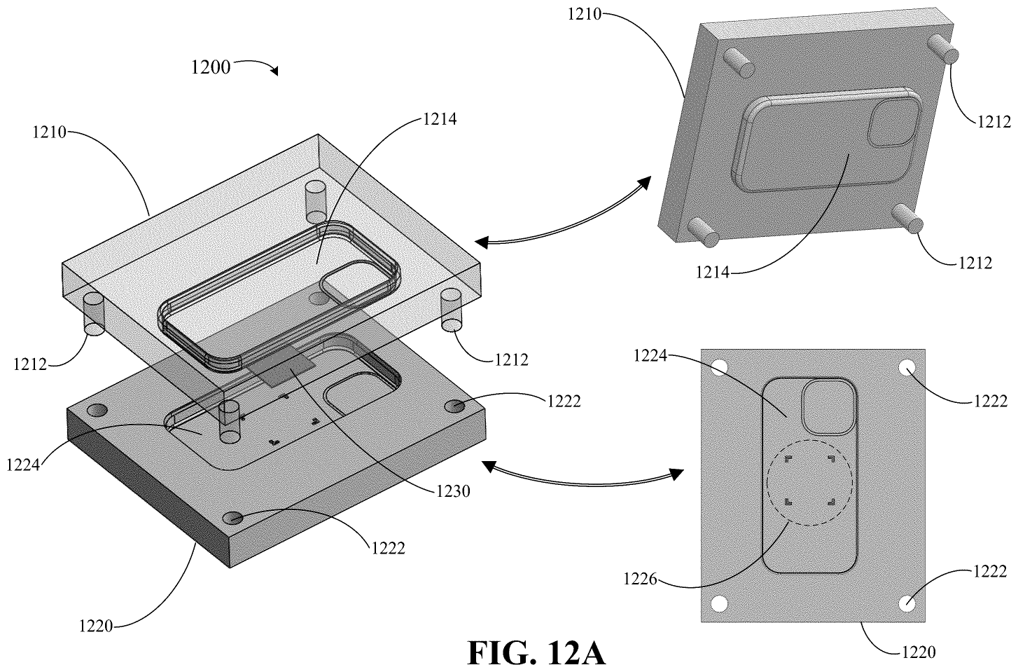

FIG. 11 provides a flow diagram illustrating an example method 1100 of constructing a mobile device case with a coil repeater assembly for wireless charging according to one or more embodiments, with reference to components and features described herein including but not limited to the figures and associated description. Block 1110 provides for forming a microchannel coil disposed within a first surface of a case body of a mobile device case. Block 1120 provides for filling the microchannel coil with a conductive material to form an inductive coil. In some embodiments, the conductive material is a metal in liquid or paste form. Block 1130a provides for electrically connecting a tuning capacitor to each end of the inductive coil to form a wireless charging repeater circuit, where at block 1130b the wireless charging repeater circuit excludes electrical connection to an active component that supplies power. Block 1140 provides that the inductive coil is located proximate to a wireless charging coil in a mobile device when the mobile device case is attached to the mobile device. In embodiments, the wireless charging repeater circuit corresponds to the wireless charging repeater circuit 210 (FIG. 2, already discussed).

### In-Mold Coil Repeater Assembly For Mobile Device Case

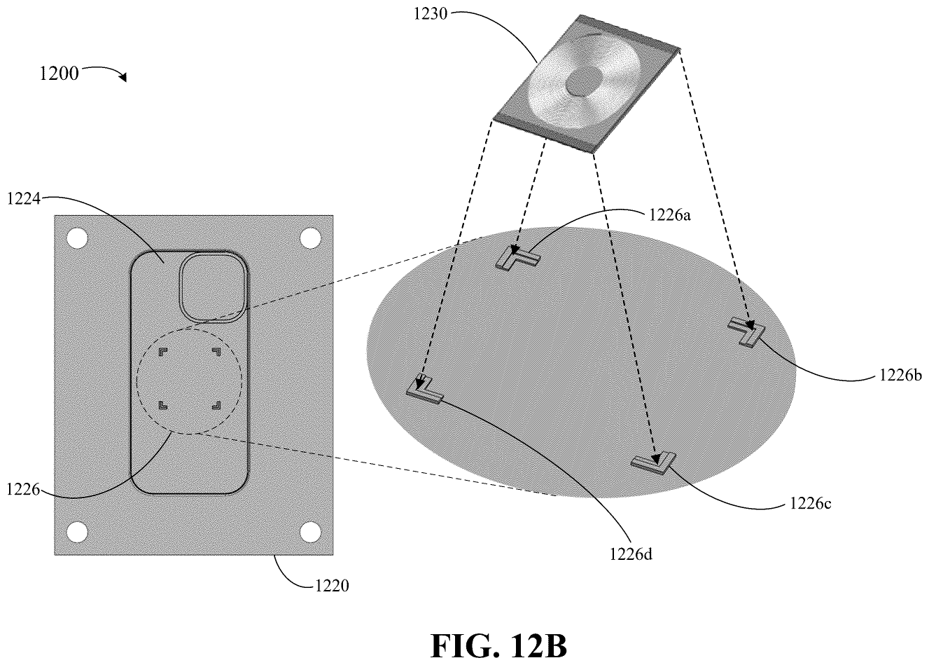

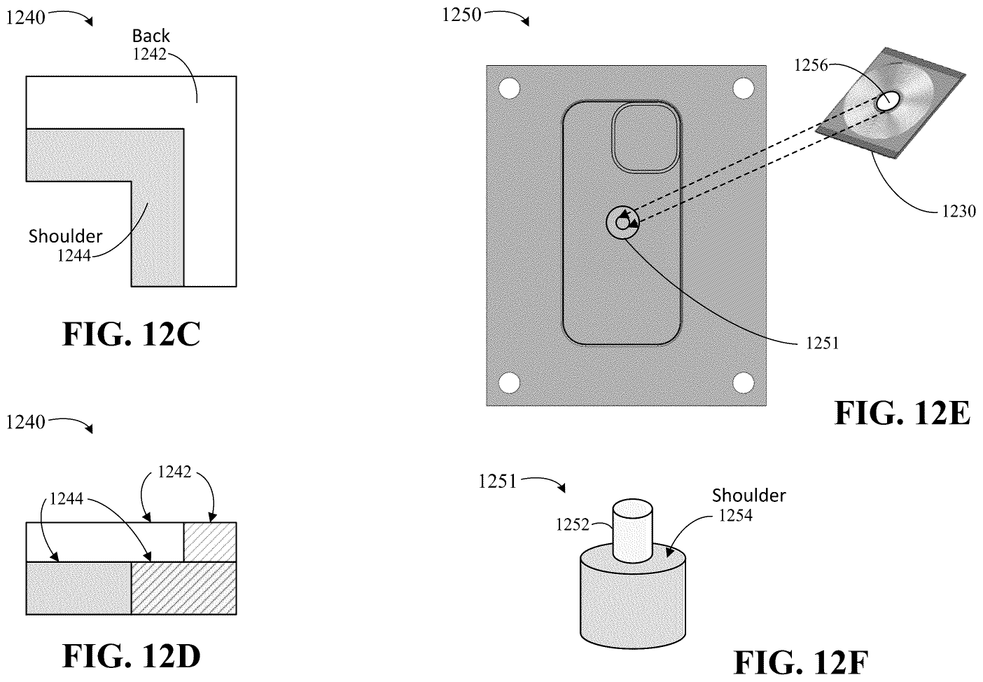

FIGS. 12A-12F illustrate examples of mold designs for constructing a mobile device case with an embedded coil repeater assembly for wireless charging according to one or more embodiments, with reference to components and features described herein including but not limited to the figures and associated description. The mold designs relate to thermomolding techniques. The mobile device case includes a coil repeater assembly 1230 embedded within the case body. The coil repeater assembly 1230 corresponds to the coil repeater assembly 320 (FIG. 3), the coil repeater assembly 400 (FIG. 4A), the coil repeater assembly 500 (FIG. 5), and/or the coil repeater assembly 600 (FIG. 6).

As shown in FIG. 12A, an example mold 1200 includes a first mold section 1210 (e.g., a top mold section) and a second mold section 1220 (e.g., bottom mold section). The first mold section 1210 includes one or more pins 1212 that are arranged such that, when first mold section 1210 and the second mold section 1220 are joined together, the pins 1212 align with holes 1222 in the second mold section 1220. Thus, when the first mold section 1210 and the second mold section 1220 are joined together to assemble the mold 1200, the pins 1212 are inserted into the holes 1222 to hold the mold sections 1210 and 1220 in place as aligned.

The mold 1200 is used to produce a mobile device case. The first mold section 1210 includes a mold portion 1214 and the second mold section 1220 includes a mold portion 1224 such that, when the mold 1200 is assembled (e.g., the mold sections are joined together), the mold 1200 provides a mold cavity. The mold cavity is shaped, e.g., by the mold portion 1214 and the mold portion 1224, and defines surfaces of a case body for a mobile device case. The mold cavity defines both an interior surface of the mobile device case (defined, e.g., by the surface of the mold portion 1214 of the first mold section 1210) and an exterior surface of the mobile device case (defined, e.g., by the surface of the mold portion 1224 of the second mold section 1220). To produce the mobile device case, the mold cavity of the assembled mold 1200 is filled with a heated thermoplastic material, which is then cooled to form the particular mobile device case.

The second mold section 1220 includes one or more pedestal element(s) 1226 situated on a surface of the second mold portion 1224. During manufacture of the mobile device case, a coil repeater assembly 1230 is placed on the pedestal element(s) 1226 in the second mold section 1220 (e.g., prior to filling the mold 1200 with thermoplastic material). The pedestal element(s) 1226 hold the coil repeater assembly 1230 in place within the mold cavity such that, when the mold 1200 is assembled and the mold cavity is filled with heated thermoplastic material, the heated thermoplastic plastic material flows around the coil repeater assembly 1230—including over and under the coil repeater assembly 1230. The thermoplastic material effectively completely surrounds the coil repeater assembly 1230—except for those portions of the coil repeater assembly 1230 that are in physical contact with the pedestal element(s) 1226. As a result, the coil repeater assembly 1230 is embedded within the case body.

In some embodiments, the pedestal element(s) 1226 are located on the second mold portion 1224 of the second mold section 1220 (e.g., defining the exterior surface of the mobile device case). In some embodiments, the pedestal element(s) 1226 are located on the first mold portion 1214 of the first mold section 1210 (e.g., defining the interior surface of the mobile device case). Further details regarding the pedestal element(s) 1226 are provided herein with reference to FIGS. 12B-12F.

Turning now to FIG. 12B, additional details regarding the example mold 1200 are illustrated. In the example of FIG. 12B, the second mold section 1220 includes four (4) pedestal elements 1226, indicated as 1226a-1226d. These pedestal elements 1226a-1226d are sized and fitted (e.g., with stepped regions) to hold the coil repeater assembly 1230 in position when the coil repeater assembly 1230 is placed on the pedestal elements 1226a-d. The pedestal elements 1226a-d are spaced on the second mold section 1220 such that the corners of the coil repeater assembly 1230 fit into the stepped regions of respective pedestals 1226a-d. While the example of FIG. 12B shows four (4) pedestal elements 1226a-1226d, a different number of pedestal element(s) 1226 can be used for the second mold section 1220. For example, in some embodiments two (2) pedestal elements 1226 (e.g., 1226a and 1226c) are used, which are spaced to hold opposite corners of the coil repeater assembly 1230. In some embodiments other configurations of pedestal elements 1226 are used (e.g., three (3) pedestal elements, etc.).

FIGS. 12C and 12D provide additional views of an example pedestal element 1240. In embodiments the pedestal element 1240 corresponds to one of the pedestal elements 1226 (e.g., 1226a, 1226b, 1226c or 1226d) illustrated in FIG. 12B. FIG. 12C provides a top view of the pedestal element 1240 and FIG. 12D provides a side view of the pedestal element 1240. As shown in FIGS. 12C and 12D, the pedestal element 1240 has a stepped region that includes a back 1242 and a shoulder 1244. The pedestal element 1240 is shaped such that a corner of the coil repeater assembly 1230 fits onto the shoulder 1244 (i.e., the corner rests on the shoulder 1244), while the back 1242 holds the corner of the coil repeater assembly 1230 in place.

In embodiments, the height of the back 1242 extending above the shoulder 1244 is sized to be approximately the thickness of the coil repeater assembly 1230 (and/or the thickness of the substrate of the coil repeater assembly 1230). In embodiments, the height of the shoulder 1244 is sized to provide for a desired thickness of the portion of the mobile device case that is formed under the coil repeater assembly 1230.

Turning now to FIG. 12E, another example mold section 1250 is illustrated. In embodiments the mold section 1250 is a second mold section that is substituted for the second mold section 1220 (FIG. 12A). The mold section 1250 includes holes arranged to receive the pins 1212 of the first mold section 1210 (FIG. 12A). Thus, when the first mold section 1210 and the mold section 1250 are joined together, the assembled mold 1200 provides a mold cavity (e.g., similar to the mold cavity as described herein with reference to FIG. 12A) that defines surfaces of a case body for a mobile device case.

The mold section 1250 includes a single pedestal element 1251 that is sized and positioned to hold the coil repeater assembly 1230 in place within the mold cavity. As illustrated in FIG. 12F, the pedestal element 1251 includes a pin 1252 and a shoulder 1254. The pin 1252 is sized to fit through a hole 1256 in the coil repeater assembly 1230. Thus, when the coil repeater assembly 1230 (with the hole 1256) is placed on the pedestal element 1251, the pin 1252 fits through the hole 1256 and the coil repeater assembly 1230 rests on the shoulder 1254. As such, the pedestal element 1251 holds the coil repeater assembly 1230 in place within the mold cavity such that, when the mold 1200 is assembled and the mold cavity is filled with heated thermoplastic material, the heated thermoplastic plastic material flows around the coil repeater assembly 1230—including over and under the coil repeater assembly 1230. As a result, the coil repeater assembly 1230 is embedded within the case body.

In embodiments, the height of the pin 1252 extending above the shoulder 1254 is sized to be approximately the thickness of the coil repeater assembly 1230 (and/or the thickness of the substrate of the coil repeater assembly 1230). In embodiments, the height of the shoulder 1254 is sized to provide for a desired thickness of the portion of the mobile device case that is formed under the coil repeater assembly 1230.

The coil repeater assembly 1230 is positioned within the case body (i.e., based on the position of the pedestal element(s) in the mold 1200) such that, when the mobile device case is attached to a mobile device, the inductive coil L_{R} of the wireless charging repeater circuit is located proximate to a wireless charging coil (e.g., the coil L₂) in the mobile device. For example, in embodiments, when the mobile device case is attached to the mobile device, the coil L_{R} is located parallel to and within a short distance from the wireless charging coil. Further, the center of the coil of the coil repeater assembly 1230 is aligned (at least approximately) with the center of the wireless charging coil in the mobile device. The location of the wireless charging coil can depend on the manufacturer and model of the mobile device and, thus, the location of the coil within the mobile device case can likewise be positioned based on the manufacturer and model of the mobile device for which the mobile device case is intended to fit.

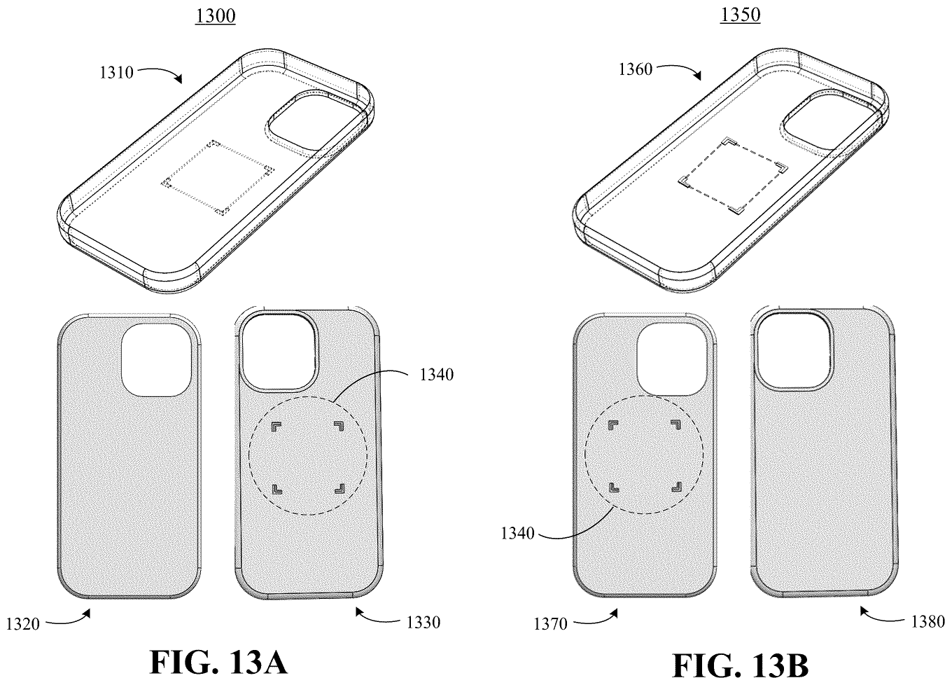

FIGS. 13A-13B illustrate examples of mobile device cases with an embedded coil repeater assembly for wireless charging according to one or more embodiments, with reference to components and features described herein including but not limited to the figures and associated description. FIG. 13A illustrates an example mobile device case 1300 produced using the example mold 1200 as shown and described herein with reference to FIGS. 12A-12D. In the example of FIG. 13A, the pedestal elements 1226a-1226d of the mold 1200 were positioned on the second mold section 1220 (e.g., defining the exterior surface of the mobile device case). FIG. 13A shows a perspective view 1310 of the interior surface (e.g., inside/hidden surface when the case is attached to a mobile device) of the mobile device case 1300, a top view 1320 showing the interior surface of the mobile device case 1300, and a bottom view 1330 showing the exterior surface (e.g., outside/visible surface when the case is attached to a mobile device) of the mobile device case 1300.

The perspective view 1310 illustrates, with dotted lines, the location of the embedded coil repeater assembly 1230 and the location of the pedestal elements 1226a-1226d of the mold 1200 in relation to the embedded coil repeater assembly 1230. The top view 1320 shows that the embedded coil repeater assembly 1230 is not visible from the interior surface of the mobile device case 1300. As illustrated in the bottom view 1330, the exterior surface of the mobile device case 1300 includes four small holes 1340 (shown inside the dotted line circle) that are visible along with a small portion of edges (e.g., corners) of the embedded coil repeater assembly 1230. Otherwise, the remainder of the embedded coil repeater assembly 1230 is not visible. The holes 1340 are remnants of the process of manufacturing the mobile device case 1300, and result from the pedestal elements 1226a-1226d which occupy a small volume in the mold cavity that is not filled with the thermoplastic material during manufacture of the mobile device case 1300. Thus, the holes 1340 show the location of the pedestal elements 1226a-1226d that were present in the mold cavity during manufacture, and the number of holes corresponds to the number of pedestal elements present in the mold cavity. In some embodiments, after the mold has been removed from the manufactured mobile device case the holes 1340 are filled in (e.g., with a similar plastic material as the case body) or covered.

In operation, with the mobile device case 1300 attached to the mobile device (such as, e.g., the mobile device 330), the mobile device case 1300 is placed in proximity to an external wireless charger (such as, e.g., the external charger 110 in FIGS. 1-2, already discussed), such that the external wireless charger, the wireless charging repeater circuit (part of the mobile device case 1300), and the mobile device form a wireless charging configuration (e.g., such as, e.g., the wireless charging configuration 200 in FIG. 2, already discussed). As such, the wireless charging configuration operates as described with reference to the wireless charging configuration 200 in FIG. 2. In particular, when exposed to a changing magnetic field from the external wireless charger, the wireless charging repeater circuit operates to generate a magnetic field that passes (e.g., permeates or radiates) into the wireless charging coil (e.g., the coil L₂) in the mobile device.

Turning now to FIG. 13B, an example mobile device case 1350 is illustrated. The mobile device case 1350 has features and components that are the same as or similar to the mobile device case 1300 (FIG. 13A) which will not be repeated herein except as to describe the mobile device case 1350. The mobile device case 1350 is produced using the example mold 1200 as shown and described herein with reference to FIGS. 12A-12D, except that the pedestal elements 1226a-1226d of the mold 1200 were positioned on the first mold section 1210 (e.g., defining the interior surface of the mobile device case) rather than on the second mold section 1220. FIG. 13B shows a perspective view 1360 of the interior surface (e.g., inside/hidden surface when the case is attached to a mobile device) of the mobile device case 1300, a top view 1370 showing the interior surface of the mobile device case 1300, and a bottom view 1380 showing the exterior surface (e.g., outside/visible surface when the case is attached to a mobile device) of the mobile device case 1300.

The perspective view 1360 illustrates, with dotted lines, the location of the embedded coil repeater assembly 1230 and the location of the pedestal elements 1226a-1226d of the mold 1200 in relation to the embedded coil repeater assembly 1230. The top view 1370 shows that, while most of the embedded coil repeater assembly 1230 is not visible from the interior surface of the mobile device case 1350, the interior surface includes four small holes 1340 that are visible along with a small portion of edges (e.g., corners) of the embedded coil repeater assembly 1230). That is, the holes 1340 are visible from the interior surface of the mobile device case 1350 rather than from the exterior surface. In some embodiments, the holes 1340 are filled in or covered after the mold has been removed from the manufactured mobile device case. As illustrated in the bottom view 1380, the embedded coil repeater assembly 1230 is not visible from the exterior surface of the mobile device case 1350.

In operation, with the mobile device case 1350 attached to the mobile device (such as, e.g., the mobile device 330), the mobile device case 1350 is placed in proximity to an external wireless charger (such as, e.g., the external charger 110 in FIGS. 1-2, already discussed), such that the external wireless charger, the wireless charging repeater circuit (part of the mobile device case 1350), and the mobile device form a wireless charging configuration (e.g., such as, e.g., the wireless charging configuration 200 in FIG. 2, already discussed). As such, the wireless charging configuration operates as described with reference to the wireless charging configuration 200 in FIG. 2. In particular, when exposed to a changing magnetic field from the external wireless charger, the wireless charging repeater circuit operates to generate a magnetic field that passes (e.g., permeates or radiates) into the wireless charging coil (e.g., the coil L₂) in the mobile device.

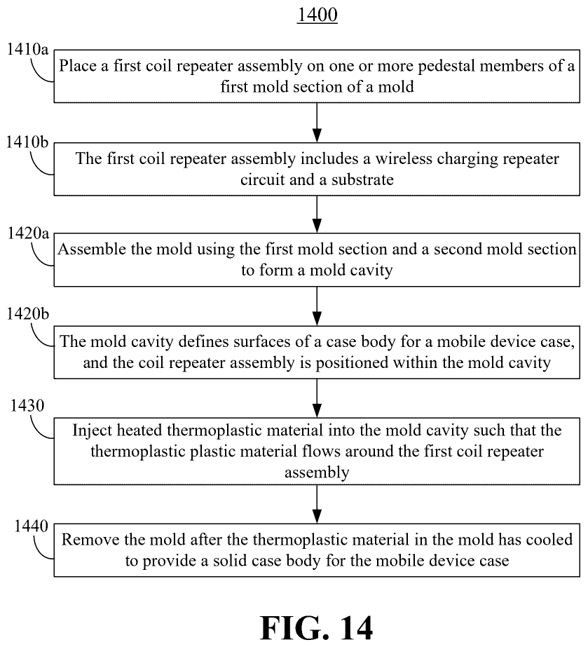

FIG. 14 provides a flow diagram illustrating an example method 1400 of constructing a mobile device case with an embedded coil repeater assembly for wireless charging according to one or more embodiments, with reference to components and features described herein including but not limited to the figures and associated description. The method 1400 provides a technique for manufacturing a mobile device case (such as, e.g., the mobile device case 1300 of FIG. 13A and/or the mobile device case 1350 of FIG. 13B) using thermomolding techniques (e.g., as described herein with reference to FIGS. 12A-12F). Block 1410a provides for placing a first coil repeater assembly on one or more pedestal members of a first mold section of a mold, where at block 1410b the first coil repeater assembly includes a wireless charging repeater circuit and a substrate. Block 1420a provides for assembling the mold using the first mold section and a second mold section to form a mold cavity, where at block 1420b the mold cavity defines surfaces of a case body for a mobile device case, and the coil repeater assembly is positioned within the mold cavity. Block 1430 provides for injecting heated thermoplastic material into the mold cavity such that the thermoplastic plastic material flows around the first coil repeater assembly. Block 1440 provides for removing the mold after the thermoplastic material in the mold has cooled to provide a solid case body for the mobile device case.

The wireless charging repeater circuit used in the method 1400 includes a first inductive coil disposed on a first surface of the substrate, and a first tuning capacitor electrically coupled to each end of the first inductive coil. The wireless charging repeater circuit excludes electrical connection to an active component that supplies power. The first coil repeater assembly is located within the case body such that, when the mobile device case is attached to a mobile device, the first inductive coil is located proximate to a wireless charging coil in the mobile device.

In some embodiments, the first coil repeater assembly is substantially embedded within the case body such that only a portion of one or more edges of the substrate are exposed to a case body surface. In some embodiments, when the mobile device case is attached to a mobile device, the case body surface is an inside surface of the case body, the inside surface facing toward the mobile device. In some embodiments, when the mobile device case is attached to a mobile device, the case body surface is an outside surface of the case body, the outside surface facing away from the mobile device. In some embodiments, the substrate comprises a printed circuit board material. In some embodiments, the first coil repeater assembly includes a magnetic core located in the center of the first inductive coil.

In some embodiments, a second coil repeater assembly is placed in the first mold section parallel to the first coil repeater assembly prior to injecting the heated thermoplastic material into the mold cavity. In such embodiments, the second coil repeater assembly includes a second inductive coil disposed on a first surface of a second substrate, and a second tuning capacitor electrically coupled to each end of the second inductive coil, where the second inductive coil and the second tuning capacitor are part of the wireless charging repeater circuit.

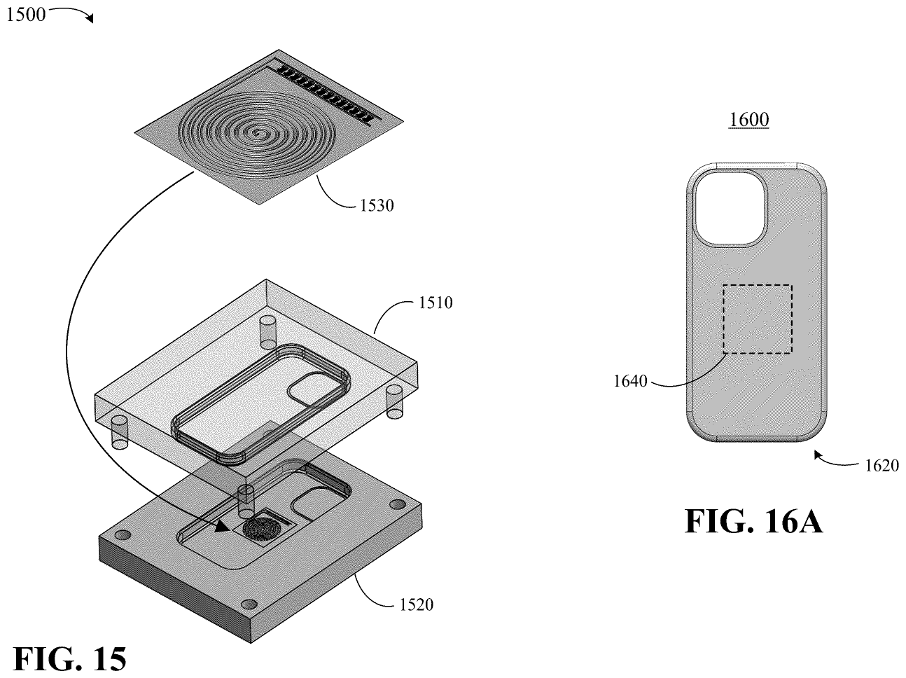

FIG. 15 illustrates another example of constructing a mobile device case with an embedded coil repeater assembly for wireless charging according to one or more embodiments, with reference to components and features described herein including but not limited to the figures and associated description. The example of FIG. 15 relates to thermomolding techniques using a conventional mold 1500 to manufacture a mobile device case. As shown in FIG. 15, the conventional mold 1500 includes a first mold section 1510 (e.g., a top mold section) and a second mold section 1520 (e.g., bottom mold section). The mold sections 1510 and 1520 are both conventional mold sections for manufacturing a mobile device case. That is, while the mold sections 1510 and 1520 are similar to the mold sections 1210 and 1220 (described herein with reference to FIGS. 12A-12B), there is an important difference—neither of the mold sections 1510 and 1520 include pedestal element(s) 1226. When the mold sections 1510 and 1520 are joined together, the assembled mold 1500 provides a mold cavity (similar to the mold cavity described herein for the mold 1200) that defines surfaces of a case body for a mobile device case. For example, an interior surface of the case body is defined by the surface of the first mold section 1510 and an exterior surface of the case body is defined by the surface of the second mold section 1520.

The mobile device case to be manufactured using the mold 1500 will include a coil repeater assembly 1530. The coil repeater assembly 1530 is similar to the coil repeater assembly 1230 (FIG. 12A), and includes a wireless charging repeater circuit and a substrate. The substrate of the coil repeater assembly 1530 includes a plastic sheet (e.g., a flat plastic sheet). In embodiments, the plastic sheet is made from the same thermoplastic material used for the mobile device case (and in some embodiments the plastic sheet is the same color as the thermoplastic material used for the mobile device case). In some embodiments, the thickness of the plastic sheet (i.e., the substrate of the coil repeater assembly 1530) is approximately ten percent (10%) of the thickness of the case body. As one example, where a case body thickness is in a range of 1-3 mm, the thickness of the plastic sheet is within a range of approximately 0.1 mm to 0.3 mm. In some embodiments, the plastic sheet has a thickness of up to 0.5 mm (e.g., a maximum thickness of 0.5 mm) regardless of the thickness of the case body.

The wireless charging repeater circuit of the coil repeater assembly 1530 corresponds to the wireless charging repeater circuit 210 (FIG. 2), and includes an inductive coil (e.g., L_{R}) and tuning capacitor(s) (e.g., C_{R}) that is electrically coupled to each end of the coil L_{R}. An ink circuit including the inductive coil (e.g., L_{R}) is disposed on the substrate (e.g., plastic sheet) via an ink printing technique using conductive ink. The tuning capacitor(s) are thin capacitors (e.g., thin film capacitors) that are thinner than the mobile device case body. The ink circuit includes the coil, electrical connections, and attachment pads for any passive components such as, e.g., the tuning capacitor(s).

To manufacture the mobile device case, a coil repeater assembly 1530 is placed on a surface of the second mold section 1520 (e.g., the mold section defining the exterior surface of the mobile device case body)—this is typically done before assembling the mold 1500. The surface of the substrate having the ink printed coil faces inward into the mold cavity. The mold 1500 is assembled using the first mold section 1510 and the second mold section 1520—with the coil repeater assembly 1530 on a surface of the coil repeater assembly 1530—and as a result the coil repeater assembly 1530 is positioned within the mold cavity of the assembled mold 1500. To produce the mobile device case, the mold cavity of the mold 1500 is filled with a heated thermoplastic material, which is then cooled to form the particular mobile device case.

As the mold cavity is filled with heated thermoplastic material, the heated thermoplastic plastic material flows over (but typically not under) the coil repeater assembly 1530, and bonds to the substrate. Thus, the thermoplastic material effectively surrounds the coil repeater assembly 1530 (except for the back surface of the substrate of the coil repeater assembly 1530). As a result, the coil repeater assembly 1530 is embedded in the case body, and the back surface of the substrate (i.e., the surface on an opposite side of the surface on which the inductive coil (e.g., L_{R}) is disposed) forms a part of the exterior surface of the case body. In embodiments where the material of the substrate is the same type and color as the material injected into the mold 1500 (e.g., same appearance), the substrate blends in with the rest of the case body. In some embodiments, accurate control of the temperature inside the mold is provided during the thermomolding process. At the appropriate temperature for the thermoplastic material, the injected material is in the form of flowing fluid while the placed substrate is still in solid form—but the edge of the substrate will be softened and bonded to the injected material.

The coil repeater assembly 1530 is positioned within the case body (i.e., based on the position when placed on the mold section 1520) such that, when the mobile device case is attached to a mobile device, the inductive coil L_{R} of the wireless charging repeater circuit is located proximate to a wireless charging coil (e.g., the coil L₂) in the mobile device. For example, in embodiments, when the mobile device case is attached to the mobile device, the coil L_{R} is located parallel to and within a short distance from the wireless charging coil. Further, the center of the coil of the coil repeater assembly 1530 is aligned (at least approximately) with the center of the wireless charging coil in the mobile device. The location of the wireless charging coil can depend on the manufacturer and model of the mobile device and, thus, the location of the coil within the mobile device case can likewise be positioned based on the manufacturer and model of the mobile device for which the mobile device case is intended to fit.

In some embodiments, a coil repeater assembly 1530 includes a plurality of substrate layers (e.g., 2 or 3 layers), where the substrate layers can be stacked as overlays. Ink can be deposited between layers to form part of the ink circuit. Any necessary connections between parts of the ink circuit on the various layers can be made using via holes, vertical pins, connectors, etc. In some embodiments, when 3 layers are used, via holes can be slightly staggered from layer to layer.

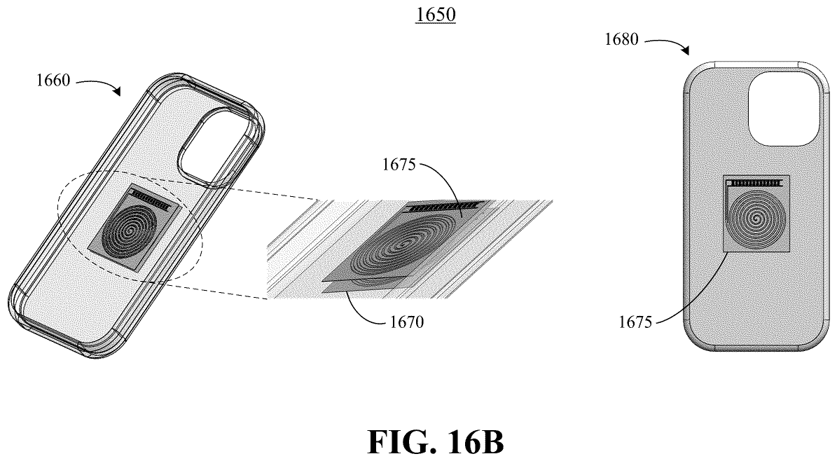

FIGS. 16A-16B illustrate examples of mobile device cases with an embedded coil repeater assembly for wireless charging according to one or more embodiments, with reference to components and features described herein including but not limited to the figures and associated description. FIG. 16A illustrates an example mobile device case 1600 produced using the mold 1500 as shown and described herein with reference to FIG. 15. The mobile device case 1600 includes an embedded coil repeater assembly 1530 (e.g., as described herein with reference to FIG. 15). FIG. 16A shows a bottom view 1620 showing the exterior surface (e.g., outside/visible surface when the case is attached to a mobile device) of the mobile device case 1600. The bottom view 1620 illustrates, with dotted lines, the location 1640 of the embedded coil repeater assembly 1530—including the location of the back side of the substrate of the coil repeater assembly 1530. In embodiments where the material of the substrate is the same type and color as the material (e.g., same appearance) for the case body that is injected into the mold 1500, the substrate blends in with the rest of the case body of the mobile device case 1600.

The embedded coil repeater assembly 1530 is located in the case body of the mobile device case 1600 such that, when the mobile device case 1600 is attached to the mobile device (e.g., the mobile device 330), the inductive coil L_{R} of the wireless charging repeater circuit is located proximate to a wireless charging coil (e.g., the coil L₂) in the mobile device. For example, in embodiments, when the mobile device case 1600 is attached to the mobile device, the coil L_{R} is located parallel to and within a short distance from the wireless charging coil (where, for example, the location of the wireless charging coil in the mobile device 330 is indicated by the dotted circle 335). Further, the center of the coil L_{R} is aligned (at least approximately) with the center of the wireless charging coil (e.g., such as illustrated in FIG. 3 by the dotted line 340).

In some embodiments a second coil repeater assembly 1530 is also embedded within the mobile device case 1600. In some embodiments having a second coil repeater assembly 1530, the mobile device case is produced by partially filling the mold cavity of the mold 1500 with heated thermoplastic material (which flows over the first embedded coil repeater assembly 1530). The mold cavity is partially filled with a first layer to embed the first coil repeater assembly 1530. For example, the mold cavity is partially filled to fifty percent (50%) capacity. In one example, if the thickness of the mobile device case is to be 1 mm, the first layer will be 0.5 mm, and a second layer (described below) will be 0.5 mm.

The material is allowed to cool, and the mold 1500 is temporally disassembled. A second coil repeater assembly 1530 is placed on the interior surface (e.g., first layer) of the partially-finished case body. The second coil repeater assembly 1530 is positioned parallel to the first second coil repeater assembly 1530 such that the coils of each coil repeater assembly are in alignment. Then the mold 1500 is reassembled, and the remainder of the mold cavity is filled with additional heated thermoplastic material as a second layer to embed the second coil repeater assembly 1530. The additional thermoplastic material is allowed to cool and the mold 1500 is removed.

In operation, with the mobile device case 1600 attached to the mobile device (such as, e.g., the mobile device 330), the mobile device case 1600 is placed in proximity to an external wireless charger (such as, e.g., the external charger 110 in FIGS. 1-2, already discussed), such that the external wireless charger, the wireless charging repeater circuit (part of the mobile device case 1600), and the mobile device form a wireless charging configuration (e.g., such as, e.g., the wireless charging configuration 200 in FIG. 2, already discussed). As such, the wireless charging configuration operates as described with reference to the wireless charging configuration 200 in FIG. 2. In particular, when exposed to a changing magnetic field from the external wireless charger, the wireless charging repeater circuit operates to generate a magnetic field that passes (e.g., permeates or radiates) into the wireless charging coil (e.g., the coil L₂) in the mobile device.

FIG. 16B illustrates another example mobile device case 1650 produced using the example mold 1500 as shown and described herein with reference to FIG. 15. The mobile device case 1650 has features and components that are the same as or similar to the mobile device case 1600 (FIG. 16A) which will not be repeated herein except as to describe the mobile device case 1650. The mobile device case 1650 includes an embedded coil repeater assembly 1670 (e.g., similar to the embedded coil repeater assembly 1530 as described herein with reference to FIG. 15) along with a second coil repeater assembly 1675. Each of the coil repeater assembly 1670 and the second coil repeater assembly 1675 corresponds to the coil repeater assembly 1530 (FIG. 15, already discussed).

The embedded coil repeater assembly 1670 is located of the case body of the mobile device case 1650 such that, when the mobile device case 1650 is attached to the mobile device (e.g., the mobile device 330), the inductive coil L_{R} of the wireless charging repeater circuit is located proximate to a wireless charging coil (e.g., the coil L₂) in the mobile device. For example, in embodiments, when the mobile device case 1650 is attached to the mobile device, the coil L_{R} is located parallel to and within a short distance from the wireless charging coil (where, for example, the location of the wireless charging coil in the mobile device 330 is indicated by the dotted circle 335). Further, the center of the coil L_{R} is aligned (at least approximately) with the center of the wireless charging coil (e.g., such as illustrated in FIG. 3 by the dotted line 340).

In embodiments the second coil repeater assembly 1675 is located on an interior surface of the mobile device case 1650. For example, once the case body for the mobile device case 1650 is manufactured (e.g., as described with reference to FIG. 15), an ink circuit including the inductive coil (e.g., L_{R}) for the second coil repeater assembly 1675 is disposed on the interior surface of the mobile device case 1650 via an ink printing technique using conductive ink. Then the tuning capacitor(s) (e.g., thin film capacitors) are added. That is, the interior surface of the mobile device case 1650 acts as a substrate for the second coil repeater assembly 1675. The ink circuit includes the coil, electrical connections, and attachment pads for any passive components such as, e.g., the tuning capacitor(s). The inductive coil (e.g., L_{R}) for the second coil repeater assembly 1675 is located parallel to the coil repeater assembly 1670, such that the coils of each coil repeater assembly are in alignment. Any necessary connections between the coil repeater assembly 1670 and the second coil repeater assembly 1675 can be made using via holes, vertical pins, connectors, etc.

FIG. 16B shows a perspective view 1660 of the interior surface (e.g., inside/hidden surface when the case is attached to a mobile device) of the mobile device case 1650, and a top view 1680 showing the interior surface of the mobile device case 1650. Although a bottom view of the mobile device case 1650 is not shown, the appearance of the exterior surface of the mobile device case 1650 is the same as the exterior surface of the mobile device case 1600 (e.g., as shown in the bottom view 1620 of FIG. 16A).

The perspective view 1660 illustrates, with dotted lines, the location of the embedded coil repeater assembly 1670 and the location of second coil repeater assembly 1675 (e.g., ink printed on the interior surface of the mobile device case 1600). The top view 1680 shows that the second coil repeater assembly 1675 is visible from the interior surface of the mobile device case 1600.

In operation, with the mobile device case 1650 attached to the mobile device (such as, e.g., the mobile device 330), the mobile device case 1650 is placed in proximity to an external wireless charger (such as, e.g., the external charger 110 in FIGS. 1-2, already discussed), such that the external wireless charger, the wireless charging repeater circuit (part of the mobile device case 1650), and the mobile device form a wireless charging configuration (e.g., such as, e.g., the wireless charging configuration 200 in FIG. 2, already discussed). As such, the wireless charging configuration operates as described with reference to the wireless charging configuration 200 in FIG. 2. In particular, when exposed to a changing magnetic field from the external wireless charger, the wireless charging repeater circuit operates to generate a magnetic field that passes (e.g., permeates or radiates) into the wireless charging coil (e.g., the coil L₂) in the mobile device.

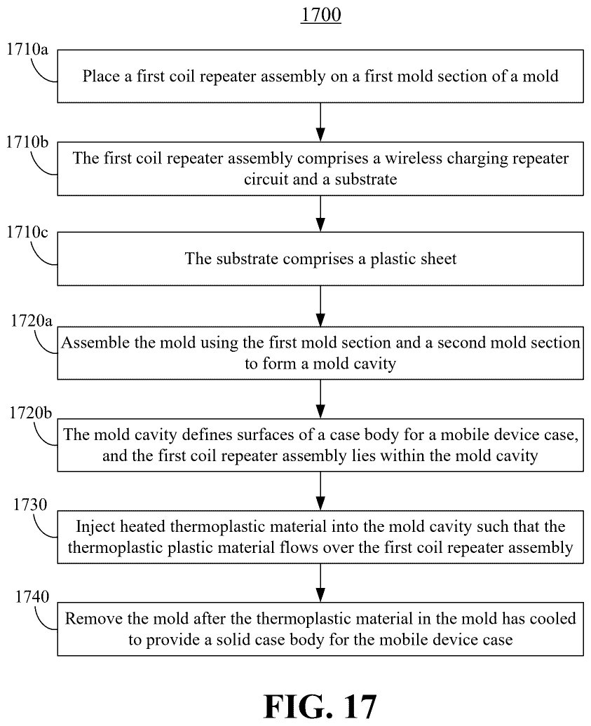

FIG. 17 provides a flow diagram illustrating an example method 1700 of constructing a mobile device case with an embedded coil repeater assembly for wireless charging according to one or more embodiments, with reference to components and features described herein including but not limited to the figures and associated description. The method 1700 provides a technique for manufacturing a mobile device case such as, e.g., the mobile device case 1600 of FIG. 16A using thermomolding techniques (e.g., as described herein with reference to FIG. 15). Block 1710a provides for placing a first coil repeater assembly on a first mold section of a mold, where at block 1710b the first coil repeater assembly includes a wireless charging repeater circuit and a substrate, and at block 1710c the substrate comprises a plastic sheet. Block 1720a provides for assembling the mold using the first mold section and a second mold section to form a mold cavity, where at block 1720b the mold cavity defines surfaces of a case body for a mobile device case, and the first coil repeater assembly lies in the mold cavity. Block 1730 provides for injecting heated thermoplastic material into the mold cavity such that the thermoplastic plastic material flows over the first coil repeater assembly. Block 1740 provides for removing the mold after the thermoplastic material in the mold has cooled to provide a solid case body for the mobile device case.

The wireless charging repeater circuit used in the method 1700 includes a first inductive coil disposed on a first surface of the substrate, and a first tuning capacitor electrically coupled to each end of the first inductive coil. The wireless charging repeater circuit excludes electrical connection to an active component that supplies power. The first coil repeater assembly is located within the case body such that, when the mobile device case is attached to a mobile device, the first inductive coil is located proximate to a wireless charging coil in the mobile device.

In some embodiments, the substrate comprises a flat sheet. In some embodiments, the flat sheet comprises a plastic material that matches an appearance of the thermoplastic material of the case body. In some embodiments, the first inductive coil is an ink-printed coil (using, e.g., conductive ink). In some embodiments, the first coil repeater assembly includes a magnetic core located in the center of the first inductive coil.

In some embodiments, the method 1700 further includes placing a second coil repeater assembly in the first mold section parallel to the first coil repeater assembly after the mold cavity is partially filled with the heated thermoplastic material, and injecting additional heated thermoplastic material into the mold cavity such that the thermoplastic plastic material flows over the second coil repeater assembly. The second coil repeater assembly includes a second inductive coil disposed on a first surface of a second substrate, and a second tuning capacitor electrically coupled to each end of the second inductive coil. The second inductive coil and the second tuning capacitor are part of the wireless charging repeater circuit. The second substrate is a second flat sheet.

In some embodiments, the method 1700 further includes ink-printing a second inductive coil of a second coil repeater assembly on a case body surface. When the mobile device case is attached to a mobile device, the case body surface is an inside surface of the case body, the inside surface facing toward the mobile device.

As described herein a coil repeater assembly (e.g., the coil repeater assembly 320, the coil repeater assembly 400, the coil repeater assembly 500, the coil repeater assembly 600, the coil repeater assembly 1230, the coil repeater assembly 1530, the coil repeater assembly 1670 and/or the coil repeater assembly 1675) can be placed in various configurations in or on a mobile device case body, on a mobile device, or elsewhere. As such, based on design criteria and the design of the respective mobile device case and mobile device, in some embodiments the coil repeater assembly is located closer to the wireless charging coil in the mobile device, and in other embodiments the coil repeater assembly is located closer to the wireless charging driver coil of the wireless charger. When the coil repeater assembly is located closer to the wireless charging coil in the mobile device, the wireless charging repeater circuit operates to concentrate the magnetic field (e.g., magnetic flux) emitted by the wireless charger into the wireless charging coil in the mobile device. When the coil repeater assembly is located closer to the wireless charging driver coil of the wireless charger, the wireless charging repeater circuit operates to redirect a larger portion of the magnetic field (e.g., magnetic flux) emitted by the wireless charger into the wireless charging coil in the mobile device.

### ADDITIONAL NOTES AND EXAMPLES

Example A1 includes a mobile device case for attachment to a mobile device, comprising a case body, and a first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is arranged on or within an interior surface of the case body such that, when the mobile device case is attached to a mobile device, the first inductive coil is located proximate to a wireless charging coil in the mobile device.

Example A2 includes the mobile device case of Example A1, wherein the substrate comprises a printed circuit board.

Example A3 includes the mobile device case of Example A1, wherein the substrate comprises a thin film and the wireless charging coil repeater circuit includes a flexible circuit or a thin film circuit.

Example A4 includes the mobile device case of Example A1, wherein the first coil repeater assembly includes a magnetic core located in the center of the first inductive coil.

Example A5 includes the mobile device case of Example A1, further comprising a first recessed region in the case body to hold at least a portion of the first coil repeater assembly.

Example A6 includes the mobile device case of Example A5, further comprising a second recessed region in the case body to hold a component of the wireless charging repeater circuit, wherein the second recessed region has a depth different than a depth of the first recessed region.

Example A7 includes the mobile device case of Example A1, wherein the first tuning capacitor comprises a plurality of physical capacitors connected in parallel.

Example A8 includes the mobile device case of Example A7, wherein the case body includes a socket to hold at least one of the plurality of physical capacitors, and wherein the at least one of the plurality of physical capacitors is removeable.

Example A9 includes the mobile device case of Example A1, further comprising a second coil repeater assembly located parallel to the first coil repeater assembly, wherein the second coil repeater assembly comprises a second substrate including a second inductive coil disposed on a first surface of the second substrate, and a second tuning capacitor electrically coupled to each end of the second inductive coil, wherein the second inductive coil and the second tuning capacitor are part of the wireless charging repeater circuit.

Example MA1 includes a method of constructing a mobile device case for attachment to a mobile device, comprising forming a first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, and arranging the first coil repeater assembly on or within an interior surface of a case body of a mobile device case such that, when the mobile device case is attached to a mobile device, the first inductive coil is located proximate to a wireless charging coil in the mobile device.

Example MA2 includes the method of Example MA1, further comprising arranging a magnetic core in the center of the first inductive coil.

Example MA3 includes the method of Example MA1, further comprising arranging at least a portion of the first coil repeater assembly within a first recessed region in the case body.

Example MA4 includes the method of Example MA3, further comprising arranging a component of the wireless charging repeater circuit within a second recessed region in the case body, wherein the second recessed region has a depth different than a depth of the first recessed region.

Example MA5 includes the method of Example MA1, wherein the first tuning capacitor comprises a plurality of physical capacitors connected in parallel, wherein at least one of the plurality of physical capacitors is removeable, and wherein the method further comprises arranging at least one of the plurality of physical capacitors in a socket in the case body.

Example MA6 includes the method of Example MA1, further comprising arranging a second coil repeater assembly located parallel to the first coil repeater assembly, wherein the second coil repeater assembly comprises a second substrate including a second inductive coil disposed on a first surface of the second substrate, and a second tuning capacitor electrically coupled to each end of the second inductive coil, and wherein the second inductive coil and the second tuning capacitor are part of the wireless charging repeater circuit.

Example B1 includes a mobile device case for attachment to a mobile device, comprising a case body, a wireless charging repeater circuit comprising an inductive coil, and a tuning capacitor electrically coupled to each end of the inductive coil, wherein the wireless charging repeater circuit excludes electrical connection to an active component that supplies power, wherein the inductive coil comprises a conductor-filled microchannel coil formed in the case body such that, when the mobile device case is attached to a mobile device, the inductive coil is located proximate to a wireless charging coil in the mobile device.

Example B2 includes the mobile device case of Example B1, wherein the conductor-filled microchannel coil comprises a metallic material that is a liquid or paste.

Example B3 includes the mobile device case of Example B1, further comprising a magnetic core located in the center of the microchannel coil.

Example B4 includes the mobile device case of Example B1, further comprising a recessed region in the case body to hold the tuning capacitor of the wireless charging repeater circuit.

Example B5 includes the mobile device case of Example B1, wherein the tuning capacitor comprises a plurality of physical capacitors connected in parallel.

Example B6 includes the mobile device case of Example B5, wherein the case body includes a socket to hold at least one of the plurality of physical capacitors, and wherein the at least one of the plurality of physical capacitors is removeable.

Example MB1 includes a method of constructing a mobile device case for attachment to a mobile device, comprising forming a microchannel coil disposed within a first surface of a case body of a mobile device case, filling the microchannel coil with a conductive material to form an inductive coil, and electrically connecting a tuning capacitor to each end of the inductive coil to form a wireless charging repeater circuit, wherein the wireless charging repeater circuit excludes electrical connection to an active component that supplies power, wherein the inductive coil is located proximate to a wireless charging coil in a mobile device when the mobile device case is attached to the mobile device.

Example MB2 includes the method of Example MB1, wherein the conductor-filled microchannel comprises a metallic material that is a liquid or paste.

Example MB3 includes the method of Example MB1, wherein the microchannel coil is formed within the first surface of the case body via injection molding or three-dimensional (3D) printing.

Example MB4 includes the method of Example MB1, wherein the microchannel coil is sealed after being filled with the conductive material.

Example MB5 includes the method of Example MB1, further comprising arranging a magnetic core in the center of the microchannel coil.

Example MB6 includes the method of Example MB1, wherein the tuning capacitor comprises a plurality of physical capacitors connected in parallel, wherein at least one of the plurality of physical capacitors is removeable, and wherein the method further comprises arranging at least one of the plurality of physical capacitors in a socket in the case body.

Example MC1 includes a method of constructing a mobile device case comprising placing a first coil repeater assembly on one or more pedestal members of a first mold section of a mold, wherein the first coil repeater assembly comprises a wireless charging repeater circuit and a substrate, assembling the mold using the first mold section and a second mold section to form a mold cavity, wherein the mold cavity defines surfaces of a case body for a mobile device case, and wherein the coil repeater assembly is positioned within the mold cavity, injecting heated thermoplastic material into the mold cavity such that the thermoplastic plastic material flows around the first coil repeater assembly, and removing the mold after the thermoplastic material in the mold has cooled to provide a solid case body for the mobile device case, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, and wherein the first coil repeater assembly is located within the case body such that, when the mobile device case is attached to a mobile device, the first inductive coil is located proximate to a wireless charging coil in the mobile device.

Example MC2 includes the method of Example MC1, wherein the first coil repeater assembly is substantially embedded within the case body such that only a portion of one or more edges of the substrate are exposed to a case body surface.

Example MC3 includes the method of Example MC1 or MC2, wherein when the mobile device case is attached to a mobile device, the case body surface is an inside surface of the case body, the inside surface facing toward the mobile device.

Example MC4 includes the method of Example MC1 or MC2, wherein when the mobile device case is attached to a mobile device, the case body surface is an outside surface of the case body, the outside surface facing away from the mobile device.

Example MC5 includes the method of any of Examples MC1-MC4, wherein the substrate comprises a printed circuit board material.

Example MC6 includes the method of any of Examples MC1-MC5, wherein the first coil repeater assembly includes a magnetic core located in the center of the first inductive coil.

Example MC7 includes the method of any of Examples MC1-MC6, wherein a second coil repeater assembly is placed in the first mold section parallel to the first coil repeater assembly prior to injecting the heated thermoplastic material into the mold cavity, and wherein the second coil repeater assembly comprises a second inductive coil disposed on a first surface of a second substrate, and a second tuning capacitor electrically coupled to each end of the second inductive coil, wherein the second inductive coil and the second tuning capacitor are part of the wireless charging repeater circuit.

Example C1 includes a mobile device case for attachment to a mobile device, comprising a case body, and a first coil repeater assembly embedded within the case body, the first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is located within the case body such that, when the mobile device case is attached to a mobile device, the first inductive coil is located proximate to a wireless charging coil in the mobile device.

Example C2 includes the mobile device case of Example C1, wherein the first coil repeater assembly is substantially embedded within the case body such that only a portion of one or more edges of the substrate are exposed to a case body surface.

Example C3 includes the mobile device case of Example C1 or C2, wherein when the mobile device case is attached to a mobile device, the case body surface is an inside surface of the case body, the inside surface facing toward the mobile device.

Example C4 includes the mobile device case of Example C1 or C2, wherein when the mobile device case is attached to a mobile device, the case body surface is an outside surface of the case body, the outside surface facing away from the mobile device.

Example C5 includes the mobile device case of any of Examples C1-C4, wherein

the substrate comprises a printed circuit board.

Example C6 includes the mobile device case of any of Examples C1-C5, wherein the first coil repeater assembly includes a magnetic core located in the center of the first inductive coil.

Example C7 includes the mobile device case of any of Examples C1-C6, further comprising a second coil repeater assembly located parallel to the first coil repeater assembly, wherein the second coil repeater assembly comprises a second inductive coil disposed on a first surface of a second substrate, and a second tuning capacitor electrically coupled to each end of the second inductive coil, wherein the second inductive coil and the second tuning capacitor are part of the wireless charging repeater circuit.

Example MD1 includes a method of constructing a mobile device case comprising placing a first coil repeater assembly on a first mold section of a mold, wherein the first coil repeater assembly comprises a wireless charging repeater circuit and a substrate, and wherein the substrate comprises a plastic sheet, assembling the mold using the first mold section and a second mold section to form a mold cavity, wherein the mold cavity defines surfaces of a case body for a mobile device case, and wherein the first coil repeater assembly lies in the mold cavity, injecting heated thermoplastic material into the mold cavity such that the thermoplastic plastic material flows over the first coil repeater assembly, and removing the mold after the thermoplastic material in the mold has cooled to provide a solid case body for the mobile device case, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is located within the case body such that, when the mobile device case is attached to a mobile device, the first inductive coil is located proximate to a wireless charging coil in the mobile device.

Example MD2 includes the method of Example MD1, wherein the plastic sheet comprises a plastic material that matches an appearance of the thermoplastic material of the case body.

Example MD3 includes the mobile device case of Example MD1 or MD2, wherein the first inductive coil is an ink-printed coil.

Example MD4 includes the method of any of Examples MD1-MD3, wherein the first coil repeater assembly includes a magnetic core located in the center of the first inductive coil.

Example MD5 includes the method of any of Examples MD1-MD4, further comprising placing a second coil repeater assembly in the first mold section parallel to the first coil repeater assembly after the mold cavity is partially filled with the heated thermoplastic material, and injecting additional heated thermoplastic material into the mold cavity such that the thermoplastic plastic material flows over the second coil repeater assembly, wherein the second coil repeater assembly comprises a second inductive coil disposed on a first surface of a second substrate, and a second tuning capacitor electrically coupled to each end of the second inductive coil, wherein the second inductive coil and the second tuning capacitor are part of the wireless charging repeater circuit, and wherein the second substrate is a second flat sheet.

Example MD6 includes the method of any of Examples MD1-MD5, further comprising ink-printing a second inductive coil of a second coil repeater assembly on a case body surface, wherein when the mobile device case is attached to a mobile device, the case body surface is an inside surface of the case body, the inside surface facing toward the mobile device.

Example D1 includes a mobile device case for attachment to a mobile device, comprising a case body, and a first coil repeater assembly embedded within the case body, the first coil repeater assembly comprising a wireless charging repeater circuit and a substrate, the substrate comprising a plastic sheet, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is located within the case body such that, when the mobile device case is attached to a mobile device, the first inductive coil is located proximate to a wireless charging coil in the mobile device.

Example D2 includes the mobile device case of Example D1, wherein the plastic sheet comprises a plastic material that matches an appearance of a plastic material of the case body.

Example D3 includes the mobile device case of Example D1 or D2, wherein the first inductive coil is an ink-printed coil.

Example D4 includes the mobile device case of any of Examples D1-D3, wherein the first coil repeater assembly includes a magnetic core located in the center of the first inductive coil.

Example D5 includes the mobile device case of any of Examples D1-D4, further comprising a second coil repeater assembly located parallel to the first coil repeater assembly, wherein the second coil repeater assembly comprises a second inductive coil, and a second tuning capacitor electrically coupled to each end of the second inductive coil, wherein the second inductive coil and the second tuning capacitor are part of the wireless charging repeater circuit.

Example D6 includes the mobile device case of any of Examples D1-D5, wherein the second inductive coil is disposed on a first surface of a second substrate, wherein the second substrate is a second plastic sheet, and wherein the second coil repeater assembly is embedded in the case body.

Example D7 includes the mobile device case of any of Examples D1-D5, wherein the second inductive coil is ink-printed on a surface of the case body, and wherein when the mobile device case is attached to a mobile device, the case body surface is an inside surface of the case body, the inside surface facing toward the mobile device.

In some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A method of constructing a mobile device case comprising:
placing a first coil repeater assembly on one or more pedestal members of a first mold section of a mold, wherein the first coil repeater assembly comprises a wireless charging repeater circuit and a substrate;
assembling the mold using the first mold section and a second mold section to form a mold cavity, wherein the mold cavity defines surfaces of a case body for a mobile device case, and wherein the coil repeater assembly is positioned within the mold cavity;
injecting heated thermoplastic material into the mold cavity such that the thermoplastic plastic material flows around the first coil repeater assembly; and
removing the mold after the thermoplastic material in the mold has cooled to provide a solid case body for the mobile device case;
wherein the wireless charging repeater circuit comprises:
a first inductive coil disposed on a first surface of the substrate, and
a first tuning capacitor electrically coupled to each end of the first inductive coil,
wherein the wireless charging repeater circuit excludes electrical connection to an active component that supplies power; and
wherein the first coil repeater assembly is located within the case body such that, when the mobile device case is attached to a mobile device, the first inductive coil is located proximate to a wireless charging coil in the mobile device.

2. The method of claim 1, wherein the first coil repeater assembly is substantially embedded within the case body such that only a portion of one or more edges of the substrate are exposed to a case body surface.

3. The method of claim 2, wherein when the mobile device case is attached to a mobile device, the case body surface is an inside surface of the case body, the inside surface facing toward the mobile device.

4. The method of claim 2, wherein when the mobile device case is attached to a mobile device, the case body surface is an outside surface of the case body, the outside surface facing away from the mobile device.

5. The method of claim 1, wherein the substrate comprises a printed circuit board material.

6. The method of claim 1, wherein the first coil repeater assembly includes a magnetic core located in the center of the first inductive coil.

7. The method of claim 1, wherein a second coil repeater assembly is placed in the first mold section parallel to the first coil repeater assembly prior to injecting the heated thermoplastic material into the mold cavity, and
wherein the second coil repeater assembly comprises:
a second inductive coil disposed on a first surface of a second substrate, and
a second tuning capacitor electrically coupled to each end of the second inductive coil,
wherein the second inductive coil and the second tuning capacitor are part of the wireless charging repeater circuit.

8. A mobile device case for attachment to a mobile device, comprising:
a case body; and
a first coil repeater assembly embedded within the case body, the first coil repeater assembly comprising a wireless charging repeater circuit and a substrate, wherein the wireless charging repeater circuit comprises:
a first inductive coil disposed on a first surface of the substrate, and
a first tuning capacitor electrically coupled to each end of the first inductive coil,
wherein the wireless charging repeater circuit excludes electrical connection to an active component that supplies power;
wherein the first coil repeater assembly is located within the case body such that, when the mobile device case is attached to a mobile device, the first inductive coil is located proximate to a wireless charging coil in the mobile device.

9. The mobile device case of claim 8, wherein the first coil repeater assembly is substantially embedded within the case body such that only a portion of one or more edges of the substrate are exposed to a case body surface.

10. The mobile device case of claim 9, wherein when the mobile device case is attached to a mobile device, the case body surface is an inside surface of the case body, the inside surface facing toward the mobile device.

11. The mobile device case of claim 9, wherein when the mobile device case is attached to a mobile device, the case body surface is an outside surface of the case body, the outside surface facing away from the mobile device.

12. The mobile device case of claim 8, wherein the substrate comprises a printed circuit board.

13. The mobile device case of claim 8, wherein the first coil repeater assembly includes a magnetic core located in the center of the first inductive coil.

14. The mobile device case of claim 8, further comprising a second coil repeater assembly located parallel to the first coil repeater assembly, wherein the second coil repeater assembly comprises:
a second inductive coil disposed on a first surface of a second substrate, and
a second tuning capacitor electrically coupled to each end of the second inductive coil,
wherein the second inductive coil and the second tuning capacitor are part of the wireless charging repeater circuit.

15. A method of constructing a mobile device case comprising:
placing a first coil repeater assembly on a first mold section of a mold, wherein the first coil repeater assembly comprises a wireless charging repeater circuit and a substrate, and wherein the substrate comprises a plastic sheet;
assembling the mold using the first mold section and a second mold section to form a mold cavity, wherein the mold cavity defines surfaces of a case body for a mobile device case, and wherein the first coil repeater assembly lies in the mold cavity;
injecting heated thermoplastic material into the mold cavity such that the thermoplastic plastic material flows over the first coil repeater assembly; and
removing the mold after the thermoplastic material in the mold has cooled to provide a solid case body for the mobile device case;
wherein the wireless charging repeater circuit comprises:
a first inductive coil disposed on a first surface of the substrate, and
a first tuning capacitor electrically coupled to each end of the first inductive coil,
wherein the wireless charging repeater circuit excludes electrical connection to an active component that supplies power;
wherein the first coil repeater assembly is located within the case body such that, when the mobile device case is attached to a mobile device, the first inductive coil is located proximate to a wireless charging coil in the mobile device.

16. The method of claim 15, wherein the plastic sheet comprises a plastic material that matches an appearance of the thermoplastic material of the case body.

17. The mobile device case of claim 15, wherein the first inductive coil is an ink-printed coil.

18. The method of claim 15, wherein the first coil repeater assembly includes a magnetic core located in the center of the first inductive coil.

19. The method of claim 15, further comprising:
placing a second coil repeater assembly in the first mold section parallel to the first coil repeater assembly after the mold cavity is partially filled with the heated thermoplastic material; and
injecting additional heated thermoplastic material into the mold cavity such that the thermoplastic plastic material flows over the second coil repeater assembly;
wherein the second coil repeater assembly comprises:
a second inductive coil disposed on a first surface of a second substrate, and
a second tuning capacitor electrically coupled to each end of the second inductive coil,
wherein the second inductive coil and the second tuning capacitor are part of the wireless charging repeater circuit; and
wherein the second substrate is a second flat sheet.

20. The method of claim 15, further comprising ink-printing a second inductive coil of a second coil repeater assembly on a case body surface;
wherein when the mobile device case is attached to a mobile device, the case body surface is an inside surface of the case body, the inside surface facing toward the mobile device.

21. A mobile device case for attachment to a mobile device, comprising:
a case body; and
a first coil repeater assembly embedded within the case body, the first coil repeater assembly comprising a wireless charging repeater circuit and a substrate, the substrate comprising a plastic sheet, wherein the wireless charging repeater circuit comprises:
a first inductive coil disposed on a first surface of the substrate, and
a first tuning capacitor electrically coupled to each end of the first inductive coil,
wherein the wireless charging repeater circuit excludes electrical connection to an active component that supplies power;
wherein the first coil repeater assembly is located within the case body such that, when the mobile device case is attached to a mobile device, the first inductive coil is located proximate to a wireless charging coil in the mobile device.

22. The mobile device case of claim 21, wherein the flat sheet comprises a plastic material that matches an appearance of a plastic material of the case body.

23. The mobile device case of claim 21, wherein the first coil repeater assembly includes a magnetic core located in the center of the first inductive coil.

24. The mobile device case of claim 21, wherein the first inductive coil is an ink-printed coil.

25. The mobile device case of claim 24, further comprising a second coil repeater assembly located parallel to the first coil repeater assembly, wherein the second coil repeater assembly comprises:
a second inductive coil, and
a second tuning capacitor electrically coupled to each end of the second inductive coil,
wherein the second inductive coil and the second tuning capacitor are part of the wireless charging repeater circuit.

26. The mobile device case of claim 25, wherein the second inductive coil is disposed on a first surface of a second substrate, wherein the second substrate is a second plastic sheet, and wherein the second coil repeater assembly is embedded in the case body.

27. The mobile device case of claim 25, wherein the second inductive coil is ink-printed on a surface of the case body, and wherein when the mobile device case is attached to a mobile device, the case body surface is an inside surface of the case body, the inside surface facing toward the mobile device.
